(19) United States
(12) Patent Application Publication
(10) Pub. No.: US 2010/0324992 A1
(43) Pub. Date: Dec. 23, 2010

(54) DYNAMICALLY REACTIVE RESPONSE AND SPECIFIC SEQUENCING OF TARGETED ADVERTISING AND CONTENT DELIVERY SYSTEM

(76) Inventor: James R. Birch, Spokane, WA (US)

Correspondence Address: KARL R CANNON, PO BOX 1909, SANDY, UT, 84091, US

(21) Appl. No.: 12/869,672

(22) Filed: Aug. 26, 2010

Related U.S. Application Data
(63) Continuation of application No. 12/756,957, filed on Apr. 8, 2010.
Application No. 12/756,957 is a continuation of application No. 12/544,972, filed on Aug. 20, 2009.
Application No. 12/544,972 is a continuation of application No. 12/326,021, filed on Dec. 1, 2008, now abandoned.
Application No. 12/326,021 is a continuation of application No. 12/177,068, filed on Jul. 21, 2008, now abandoned.
Application No. 12/177,068 is a continuation of application No. 12/074,554, filed on Mar. 3, 2008, now abandoned.
(60) Provisional application No. 60/928,441, filed on May 8, 2007.
(60) Provisional application No. 60/904,470, filed on Mar. 2, 2007.

(51) Int. Cl. G06Q 30/00; H04N 7/025; G06Q 10/00

(52) U.S. Cl. 705/14.49; 725/32; 725/34; 705/14.4

(57) ABSTRACT

A system for rendering advertisements in accordance with a predetermined sequence. The system may include a centralized management system for disseminating advertisements to a plurality of electronic devices. The advertisements may be rendered on the electronic devices in accordance with the predetermined sequence for the advertisements. The advertisements may be targeted towards specific users of the electronic devices whose profiles match a target profile associated with the advertisements. The system may further provide a means for rendering a reactive response upon the occurrence of a triggering event. In particular, the system may monitor a content stream for an occurrence of the triggering event. Upon the occurrence of the triggering event, the system may begin monitoring a content stream for a placement opportunity for the reactive response. The reactive response may then be rendered in accordance with the placement opportunity.

### CROSS-REFERENCE TO RELATED APPLICATIONS

This application is a continuation of U.S. application Ser. No. 12/756,957, filed Apr. 8, 2010, which is a continuation of U.S. application Ser. No. 12/544,972, filed Aug. 20, 2009, which is a continuation of U.S. application Ser. No. 12/326,021, filed Dec. 1, 2008, which is a continuation-in-part of prior U.S. application Ser. No. 12/177,068, filed Jul. 21, 2008, which is a continuation of prior U.S. application Ser. No. 12/074,554, filed Mar. 3, 2008, which claims the benefit of U.S. Provisional Application Ser. Nos. 60/928,441, filed May 8, 2007, and 60/904,470, filed Mar. 2, 2007, which are all hereby incorporated by reference herein in their entirety, including but not limited to those portions that specifically appear hereinafter, the incorporation by reference being made with the following exception: In the event that any portion of the above-referenced applications are inconsistent with this application, this application supercedes said above-referenced applications.

### STATEMENT REGARDING FEDERALLY SPONSORED RESEARCH OR DEVELOPMENT

Not Applicable.

### BACKGROUND

1. The Field of the Invention

The present disclosure relates generally to content and advertisement delivery systems and methods, and more particularly, but not necessarily entirely, to disseminating content and advertisements from a centralized management system to a plurality of electronic devices.

2. Description of Related Art

Traditional advertisement and programming delivery methods may involve delivering a content stream to multiple recipients in the same geographic area. For example, a content stream may be broadcast over the airwaves from a television station to a television located within a local area surrounding the television station. The content stream may then be rendered on the television to a user. The content stream may include both advertising and programming. The advertising in the content stream may comprise paid promotions for goods or services. The programming in the content stream may include television shows, movies, sporting events, and the like. Time slots for the advertising are typically interspersed in the programming.

The selection of advertisements to place in association with which programming is difficult at best and has in the past been subject to expensive market analysis. Historically, advertisers have been forced to purchase time slots in a content stream in association with specific programming. The selection of the specific time slots is typically based on demographic information associated with the programming. That is, the demographic information associated with the programming should match, as closely as possible, the intended demographics of the targeted audience to whom the advertising is directed. For example, in the past, in order for an advertiser to reach 35-year old women during an advertising campaign, the advertiser typically purchases time slots during a program that the research indicates that a significant portion of the audience is comprised of women that are 35-years old. Thus, the purchase of the time slots by an advertiser may be dictated by the demographics of the programming to which the time slots pertain.

It will be appreciated that the previously available advertising methods are an indirect approach to reaching the target audience with many built in inefficiencies and redundancies. One drawback to the previously available advertising methods is that the advertisements in a content stream are the same regardless of the actual demographic of the viewer. That is, many of the actual viewers of an advertisement may fall well outside of the targeted audience. When this occurs, the time slot is essentially wasted on those viewers that fall outside of the target audience. While satellite and cable content delivery systems may have the ability to provide customized advertisements based on a more refined geographic region, these systems still lack the ability of targeting individual users. Internet Protocol Television (“IPTV”) is another medium available for advertising. Using IPTV, programming is directly streamed from a remote server to a household.

Another drawback to the previously available advertising methods is the inability to conduct an advertising campaign reliably over multiple platforms to specific and targeted users. For example, if an advertiser wanted to combine a television advertisement with a follow-up direct mail piece under the previously available advertising methods, the advertiser would blanket advertisements on multiple channels during multiple time slots in an attempt to reach the target audience. At some point, once the advertiser felt that a predetermined saturation level had been reached, a follow-up direct mail piece would be sent out to the target audience. Using this method, however, the advertiser has no way of confirming if the television advertisement had actually been seen by each member of the target audience prior to the direct mail piece arriving. In fact, it is quite possible that the direct mail piece would arrive before some of the target audience had even see the television advertisement. This would of course reduce the value of the direct mail piece and the overall effectiveness of the advertising campaign.

As mentioned, television and direct mail represent two different platforms that are currently available to advertisers. Internet advertisements through banner ads and search result placements are other platforms that are available to advertisers. In addition, various other platforms which can be selected by advertisers in reaching their target audiences are currently available, including cell phones.

Further, the presently available advertising and content delivery infrastructures have built-in limitations that limit the effectiveness of advertising campaigns. Television broadcast technology, for example, was originally developed in the 1920s and deployed shortly thereafter. Aside from upgrades to color broadcasting and most recently, high definition content, the platforms and methodologies used for television are relatively unchanged. Advertisers who use these outdated platforms and methodologies in delivering advertisements and/or content are forced to adapt to these systems' inherit limitations. All advertising and content management, for example, for broadcast content delivery are controlled at remote locations and then broadcast into a geographic region. Advertisers do not have the ability to control the viewer experience as the viewer either changes the channel or content source (e.g., broadcast to PVR). As such, an advertiser may be unable to ensure that specific advertisements are shown in a particular sequence or order.

For example, perhaps an advertiser has created an advertising campaign in which Advertisement A needs to be shown first, Advertisement B second, and so on until Advertisement D. If all households only had one channel, then the advertiser could accomplish this goal to some degree although they would not be able to control the flow down to the individual level. However, in today's world, viewers utilize multiple platforms, each of which may have access to multiple content sources. Further complicating the situation is that there are typically several individuals within a given household. Cable, satellite, and IPTV suffer from these same limitations. Present infrastructures simply do not support the ability to guarantee the delivery of advertisements in a particular sequence (e.g., ABCD and not AACBDA or some other variant) to households and, more particular to targeted individuals within the households. As such, advertisers may be unable to control the specific sequencing of advertisements to households, and more specifically, to individuals within households when using traditional platforms. Furthermore, these platforms are unable to provide any time limitations (e.g., showing the desired sequence during the next 24 hours only) or across platforms (e.g., television, Internet, PVR, etc.).

In addition, in the past, advertisers have been unable to dynamically and reactively respond to advertisements viewed by a specific viewer. Political advertisements are perhaps the most relevant to this point/counter-point ability of responding immediately to a particular advertisement. If Politician A releases an advertisement in support of tax cuts, then Politician B would like a responding advertisement presented to the viewer as soon as possible to thereby counter the claims of Politician A's advertisement. Broadcast, cable, satellite, IPTV, etc., are currently unable to provide this type of dynamic and reactive response across multiple platforms and at the individual level.

The prior art is thus characterized by several disadvantages that are addressed by the present disclosure. The present disclosure minimizes, and in some aspects eliminates, the above-mentioned failures, and other problems, by utilizing the methods and structural features described herein. The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a diagram illustrating an embodiment of a system pursuant to the present disclosure;

FIG. 2 is a diagram illustrating an embodiment of the electronic device illustrated in

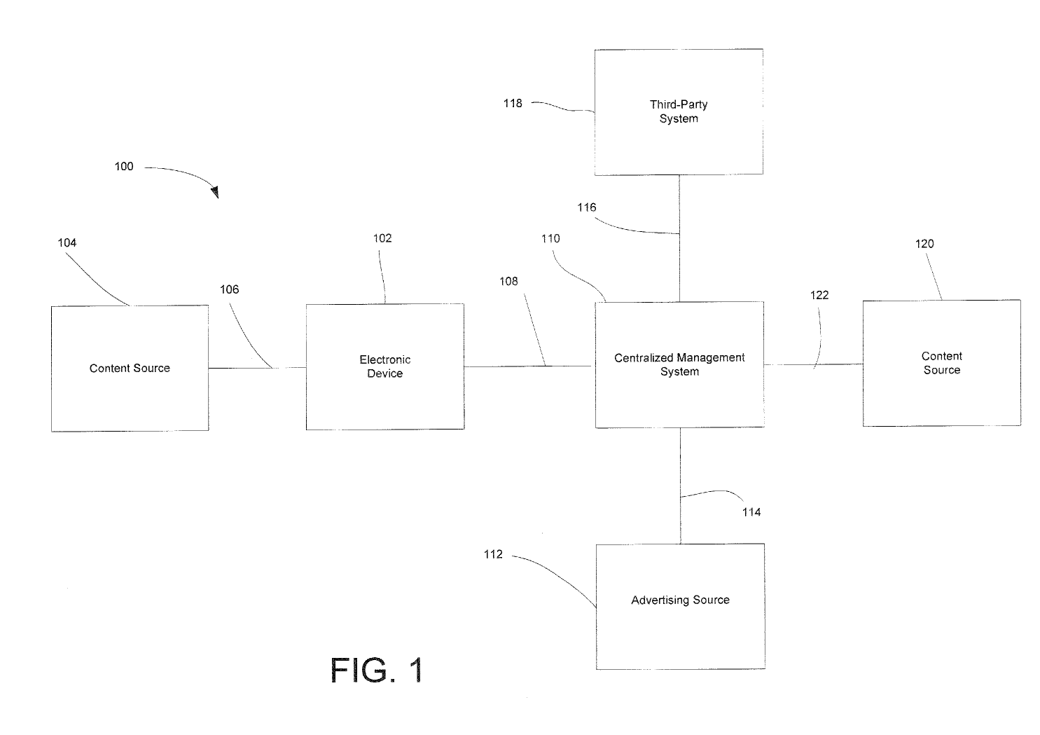

FIG. 1;

FIG. 3 is a diagram illustrating an embodiment of the centralized management system illustrated in FIG. 1;

FIG. 4 is a diagram illustrating an embodiment of a system pursuant to the present disclosure;

FIG. 5 is a flow chart according to an embodiment of the present disclosure;

FIG. 6 is a flow chart according to an embodiment of the present disclosure;

FIG. 7 is a flow chart according to an embodiment of the present disclosure;

FIG. 8 is a flow chart according to an embodiment of the present disclosure;

FIG. 9 is a flow chart according to an embodiment of the present disclosure;

FIG. 10 is a flow chart according to an embodiment of the present disclosure; and

FIG. 11 is a flow chart according to an embodiment of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “having,” “containing,” “characterized by,” and grammatical equivalents thereof are inclusive or open-ended terms that do not exclude additional, unrecited elements or method steps.

As used herein, the term “content stream” may mean information of an audio and/or visual nature that may be rendered through the use of an electronic device. The content stream may be embodied in a signal, including, without limitation, electromagnetic signals and light-based signals, either of a wired or wireless nature. The content stream may be embodied in a storage medium, including digital and analog storage mediums, such as hard drives, electronic memory, and optical storage mediums. The content stream may include information, including at least one of programming and advertisements. The content stream may be generated by a remote or local content source as described herein.

As used herein, the term “render,” and its grammatical equivalents, may mean to play, display, draw, interpret, decode, show, reproduce, or otherwise present the information in the content stream in a manner that can be perceived by a human. For example, the information in the content stream may be rendered to a user using a display, monitor, television, or screen in combination with speakers.

Further, many of the functional units described in this disclosure have been labeled as “modules,” in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software code operating on a computer, sometimes referred to as computer readable instructions, for execution by various types of microprocessors. An identified module of executable code operating on a computer may, for instance, include one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code operating on a computer may be a single instruction operating on a single computer, or many instructions on a single computer or on multiple computers, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Turning now to the present disclosure, applicant has discovered a system and method for implementing an integrated and synchronized advertisement and content delivery system. The present disclosure may include a centralized management system for disseminating the advertisements and content to a plurality of electronic devices, the users of which may be enrolled with the centralized management system. One aspect of the present disclosure may include managing multiple phases of an advertising campaign through the delivery of targeted advertisements across multiple platforms, i.e., electronic devices, to a single user. The advertising campaign may entail rendering a plurality of advertisements to a user in a predetermined sequence. Another aspect of the present disclosure may include rendering a reactive response to a user on the occurrence of a predetermined triggering event. In an embodiment of the present disclosure, the predetermined triggering event may be an occurrence of a specific advertisement in a content stream and the reactive response may include an advertisement specifically designed to counter the specific advertisement in the content stream.

The present disclosure may be able to discriminate amongst various users of an electronic device through identification techniques, such as biometric recognition techniques and non-biometric recognition techniques. Once the identification of a user is positively determined, the present disclosure may monitor a content stream being delivered to that electronic device for an advertisement placement opportunity for an advertisement specifically targeted to the identified user. Once an advertisement placement opportunity has been identified, the targeted advertisement, selected in accordance with the user's profile, may be rendered to the user according to an advertisement placement opportunity and any predetermined sequencing requirements associated with the advertisement. In this manner, the present disclosure may guarantee that a user experiences a series of advertisements in the proper sequence as dictated by an advertising campaign. After rendering of a targeted advertisement, the present disclosure may report the rendering of the targeted advertisement to the centralized management system by sending information regarding the same over a network. The receipt of the information by the centralized management system may automatically trigger the implementation of the next phase of an advertising campaign, which may include disseminating a next advertisement in the campaign to electronic devices associated with the user.

Referring now to FIG. 1, there is shown a diagram of an embodiment of a system 100 in accordance with the principles of an embodiment of the present disclosure. The system 100 may include an electronic device 102 and a centralized management system 110. The electronic device 102 may be operable to render a content stream to a user. In an embodiment of the present disclosure, the electronic device 102 may comprise a television. In an embodiment of the present disclosure, the electronic device 102 may comprise a cell phone. In an embodiment of the present disclosure, the electronic device 102 may comprise a computer, such as a handheld computer, a laptop computer, or a desktop computer. In an embodiment of the present disclosure, the electronic device 102 may comprise a portable or handheld electronic device, such as a digital music player (iPod®, mp3 player, etc.) and an internet access device. It will therefore be understood that the electronic device 102 may comprise any device that is able to render, either visually, audibly or otherwise, a content stream to a user.

A content source 104 may provide a content stream to the electronic device 102 over a communication path 106. It will be appreciated that while only one content source 104 is depicted in FIG. 1, that any number of content sources may provide a content stream to the electronic device 102. For example, the electronic device 102 may have the ability to receive different channels, such as television channels or radio channels. In an embodiment of the present disclosure, the electronic device 102 may access different websites. The communication path 106 between the content source 104 and the electronic device 102 may comprise a wireless communication path, a wired communication path, or a combination of both. In an embodiment of the present disclosure, the content source 104 may be located remotely from the electronic device 102. In an embodiment of the present disclosure, the content source 104 may be located proximate the electronic device 102. In an embodiment of the present disclosure, the content source 104 may be integrated into the electronic device 102.

The content source 104 may include, without limitation, a television station network, a communications satellite, a cable TV station, a gaming system, a web server, a cellular phone network, electronic memory, a computer server, a music player, a computer, a DVD player, a Blu-Ray disc player, an HD DVD player, a high definition optical player, a CD player, a VCR player, a tape recorder, personal video recorder (“PVR”), an IPTV station, and any other similar and equivalent devices, now known or known in the future, that are able to transmit content streams for rendering to the electronic device 102. It should therefore be understood that the content source 104 includes any device, apparatus, system or network capable of providing a content stream to the electronic device 102.

The content stream may be delivered to the electronic device 102 from the content source 104 over the communication path 106. As mentioned, the communication path 106 may comprise a wired or wireless portion. If the communication path 106 is a wireless communication path, the content stream may be transmitted using a radio frequency communication scheme such as those used for broadcast television, satellite TV, radio stations, pager networks, computer networks and cellular telephones. If the communication path 106 is a wired communication path, the content stream may be transmitted using a communication scheme commonly used for cable TV networks, computer buses, fiber optic networks, power line communication networks, telephone lines, twisted pair, CAT-5, RCA cables, HDMI cables, coaxial cables, or any other type of conductor or light transmission device used to carry analog or digital information. In short, it should be recognized that, pursuant to the present disclosure, there is no limitation on the medium through which the content stream may be delivered to the electronic device 102 from the content source 104.

It will be noted that the content stream may originate from information stored in any type of storage medium, including analog and digital storage mediums. For example, if the content source 104 is a gaming system, the content stream may be generated from information stored on a cartridge, CD, DVD, Blu-Ray disc, or an HD DVD disk. If the content source 104 is a web server, the content stream may be generated from information stored electronically on a computer-readable storage medium accessible by the web server. Further, the content stream may be generated on-demand in response to a request from the electronic device 102. In that regard, the communication path 106 may allow one-way or two-way communications.

The content stream provided by the content source 104 may be provided on-demand or pursuant to a fixed broadcast schedule. For example, in the case where the content source 104 is a web server, the content stream may be provided in response to a request from the electronic device 102. If the content source 104 is a television station or a radio network, the content stream may be broadcast pursuant to a fixed broadcast schedule. If the content source 104 is a gaming system, the content stream may be provided when the gaming system is turned on and the appropriate game is installed into the gaming system.

The content source 104 may provide the content stream in any one of a wide variety of media formats as is known to one having ordinary skill in the art. The only restriction on the formatting of the content stream is that it must be compatible for rending on the electronic device 102. Suitable formats for the content stream include all audio, video, media, proprietary, and other formats now known or known in the future. Suitable formats, include, without limitation, NTSC, HTML, DTV, AVI, Windows Media, MPEG-1, MPEG-2, MPEG-4, QuickTime, RealVideo, Flash and Shockwave. Other suitable formats include audio formats such as AAC, AC3, MIDI, MP3, RealAudio, Waveform, and WMA. Other suitable formats include image formats such as BMP, GIF, JPG, JPG 2000, MNG, PNG, SVG, TIFF. Other suitable formats include ASCII, DOC, EBCDIC, HTML, OEBPS, RTF, Unicode, WPD, and XML. Still other suitable formats include the CD, DVD, Blue-Ray, and HD DVD formats. Further, it will be noted that the content stream may be first received at an intermediary device, such as a decoder, router, gateway, satellite receiver, a cable receiver, or a high definition receiver, and then delivered to the electronic device 102.

In an embodiment of the present disclosure, the content stream provided by the content source 104 may include programming and advertising. In an embodiment of the present disclosure, the content stream may comprise programming or advertising. As used herein, the term “programming” may refer to content that a user of the electronic device 102 wishes to access, and may include, without limitation, shows, movies, websites, games, graphical user interfaces, operating systems and music. The term “advertising,” as used herein, may refer to a paid or unpaid promotion for goods, services, companies, and ideas by an advertiser. In addition, the term “advertising,” may refer to any type of solicitation of any kind.

In addition to receiving a content stream from the content source 104, the electronic device 102 may transmit and receive communications from the centralized management system 110 over a communication path 108. In an embodiment of the present disclosure, the centralized management system 110 may be located at a remote location, thereby requiring that the communication path 108 comprise a communications network. Suitable networks for the communication path 108 may include, without limitation, a computer network such as a local area network (“LAN”) or a wide area network (“WAN”). In an embodiment of the present disclosure, the communication path 108 may comprise a packet-switched network, such as the Internet. In an embodiment of the present disclosure, the communication path 108 may comprise a telephony network, such as a 3 G network.

The communication path 108 between the centralized management system 110 and the electronic device 102 may be direct or in-direct. Further, the communication path 108 may use any one of a wide variety of transmission mediums, including a wireless communication path, a wired communication path, or a combination of both, and may span one or more different networks. The electronic device 102 and the centralized management system 110 may use the appropriate communications protocol to communicate with each other as is known by one having ordinary skill in the art.

In an embodiment of the present disclosure, at least one user of the electronic device 102 may complete an enrollment process with the centralized management system 110. In an embodiment of the present disclosure, multiple users of the electronic device 102 may enroll with the centralized management system 110. For example, all of the members of a household may enroll with the centralized management system 110 as users of the electronic device 102.

The enrollment process may be completed through a wide variety of methods, including through the electronic device 102 itself, another electronic device, a live interview, or through completing a paper form. A graphical user interface, such as an interactive webpage or display, may be employed to assist in the enrollment process. In an embodiment of the present disclosure, the enrollment process may require that users complete a profile assessment by providing information in response to survey-type questions.

The enrollment process may obtain demographic information about users associated with the electronic device 102. In an embodiment of the present disclosure, the enrollment process may gather information regarding the ages of users, the sexes of users, the incomes of users, the marital and family status of users, the races of users, the residences of users, the native languages of users, credit information of users, the hobbies of users, the general and specific interests of users, and/or any other information deemed necessary to direct targeted advertisements to the users as is known to one have ordinary skill in the art. The profile and demographic information gathered from the users may be stored in a database associated with the centralized management system 110. The information may be used to generate user profiles for each user of the electronic device 102. In an embodiment of the present disclosure, the enrollment process may also allow a user to submit a biometric or non-biometric reference sample to be used in identifying the user.

In addition, during the enrollment process, a user may elect not to receive advertisements for certain products or services. For example, the user may elect not to receive alcohol or cigarette related advertisements during the enrollment process. The enrollment process may take place on-line, through a personal interview, or any other similarly related methodologies. The profile information gathered from a user may be stored in a database associated with the centralized management system 110. In addition, the enrollment process may require the user to submit a biometric or non-biometric reference sample to be used in identifying the user.

As will now be explained in greater detail, the centralized management system 110 is able to deliver targeted advertisements to users of the electronic device 102 based upon the users' profiles. As used herein, the term “targeted advertisement” means an advertisement intended for a consumer having a specific profile or fitting a certain demographic in contrast to mass advertising. The targeted advertisements may be supplied to the centralized management system 110 from an advertising source 112. Once received at the centralized management system 110, the advertisements may be stored and maintained for future dissemination to the electronic device 102.

It will be appreciated that the advertising source 112 may be operated by a third-party, such as an advertising agency or by an in-house marketing department of a company. The advertising source 112 and the centralized management system 110 may engage in communications over a communication path 114. Through the communication path 114, the advertising source 112 may transmit the targeted advertisements to the centralized management system 110. The targeted advertisements may be provided by the advertisement source 112 in a format suitable for transmission to the electronic device 102 by the centralized management system 110. Alternatively, the centralized management system 110 may have the capability to format or re-format a targeted advertisement for transmission to the electronic device 102 over the communication path 108. Further, the targeted advertisements may be provided to the centralized management system 110 on a portable storage medium, such as a CD or DVD.

In addition to the targeted advertisements, the advertisement source 112 may provide target profiles associated with each of the targeted advertisements. The target profiles may define a desired target profile of a user to whom the targeted advertisements are directed. The target profiles for the targeted advertisements may be developed by using profile information, which may contain demographic and behavioral information, stored at the centralized management system 110.

Once a targeted advertisement and its associated target profile have been received at the centralized management system 110, the centralized management system 110 may execute an operation to compare the target profile for the advertisement to the profiles of enrolled users to thereby determine a group of targeted users to whom the targeted advertisement should be delivered. It will be appreciated by those having ordinary skill in the art that the profiles of the targeted users may be only a close match to the target profile and that an exact match is not required between the target profile and a user's profile. In an embodiment of the present disclosure, there is a 90% or higher match between the target profile and a user's profile in order for the user to be targeted. In an embodiment of the present disclosure, there is an 80% or higher match between the target profile and a user's profile in order for the user to be targeted. In an embodiment of the present disclosure, there is a 70% or higher match between the target profile and a user's profile in order for the user to be targeted.

The targeted advertisement provided by the advertising source 112 may include a promotion for a product or service. The targeted advertisement may comprise a political advertisement or some other solicitation. In an embodiment of the present disclosure, the advertising source 112 may provide a plurality of targeted advertisements that are intended to be rendered pursuant to a predetermined sequence to users in accordance with an advertising campaign. That is, an advertising campaign may specify that the targeted advertisements be shown in a specific order to each targeted user. Thus, the advertising source 112 may also provide predetermined sequencing requirements for a plurality of targeted advertisements associated with an advertising campaign to the centralized management system 110 via the communication path 114.

The advertising source 112 may further provide a reactive response to the centralized management system 110 via the communication path 114. As used herein, the concept of a “reactive response” may refer generally to an advertisement, or other content or programming, that is intended to counter, rebut, refute, supplement, reply to, or otherwise respond to another advertisement or content rendered to a user. A “reactive response” may include an advertisement for a competing product or service, or the same product or service with more competitive terms. The advertising source 112 may further provide a predetermined triggering event to the centralized management system 110 via the communication path 114. As used herein, the concept of a “triggering event” may mean an event whose occurrence causes the rendering of a reactive response to a user on an electronic device. In an embodiment of the present disclosure, the triggering event may be a rendering of an advertisement in a content stream to a user, including the rendering of a political advertisement. In an embodiment of the present disclosure, the reactive response may be dynamically rendered to a user after the occurrence of a triggering event.

The centralized management system 110 may include an electronic storage medium for storing information received from the advertising source 112, information received from the electronic device 102, and information generated by the centralized management system 110. The centralized management system 110 may cause that targeted advertisements, user profile information, predetermined advertising sequence information, reactive responses and predetermined triggering events are stored locally at the centralized management system 110. In a manner that will be described in more detail hereinafter, the centralized management system 110 may disseminate the targeted advertisements, predetermined advertising sequence information, reactive responses and predetermined triggering events to the electronic device 102. The targeted advertisement, predetermined advertising sequence information, reactive responses and predetermined triggering events may be electronically stored locally to the electronic device 102. In an embodiment of the present disclosure, the centralized management system 102 may disseminate the targeted advertisement, predetermined advertising sequence information, reactive responses and predetermined triggering events to a plurality of electronic devices 102.

Each targeted advertisement disseminated to the electronic device 102 may be linked to a known user of the electronic device 102. The electronic device 102 may then access the targeted advertisement and render it to the targeted user of the electronic device 102 as specified in the link when it is determined that the targeted user is actually using the electronic device 102. The targeted advertisements may be rendered to a targeted user in accordance with advertisement placement opportunities in the content stream from the content source 104. In an embodiment of the present disclosure, the targeted advertisements displace original advertising in the content stream. In addition, the targeted advertisements may be rendered in accordance with any predetermined advertising sequence information received from the centralized management system 110.

The electronic device 102 may not render a reactive response until the occurrence of the predetermined triggering event. In this regard, the electronic device 102 may monitor a content stream from the content source 104 to determine an occurrence of the predetermined triggering event. Once the electronic device 102 has recognized an occurrence of the predetermined triggering event, the electronic device may begin monitoring the content stream for a placement opportunity for the reactive response. Once a placement opportunity has been determined, the electronic device 102 render the reactive response in accordance with the advertisement's placement opportunity.

In addition to the targeted advertisements and reactive responses, the centralized management system 110 may further provide a subscription-based content stream to the electronic device 102 over the communication path 108. The subscription-based content stream may be stored locally at the electronic device 102 in a storage medium for rendering on-demand at a later time. The subscription-based content stream may include customized programming selected by a user of the electronic device 102. The user may request the subscription-based content stream in a variety of manners. In an embodiment of the present disclosure, a user may simply select the desired programming through a user interface of the electronic device 102. The user interface may be a graphical user interface. For example, the graphical user interface may list programming available from the centralized management system 110. The programming may include television programs, movies, news, music and sporting events. The subscription-based content streams may also include subject matter based content. That is, a user may elect to receive programming related to a particular topic. For example, the user may select to receive programming related to a particular sports team, actor, hobby, or event. The centralized management system 110 would, in response, deliver the programming selected by the user in a content stream. The subscription-based content stream may be rendered in real-time on the electronic device 102. Alternatively, the subscription-based content stream is stored at the electronic device 102 for later rendering at a time convenient to the user. Control over the rendering of the subscription-based content stream may be done through a user interface associated with the electronic device 102.

It will be appreciated that the subscription-based content stream allows the delivery of programming that may otherwise be unavailable. For example, a user may desire to receive a news broadcast from a television station that does not broadcast in the geographical area where the user resides. The subscription-based content stream delivered from the centralized management system 110 allows the user to receive the news broadcast. Further, the user is able to view the news broadcast at his or her leisure thereby freeing the content stream from a fixed broadcast schedule. Further, it will be appreciated that the ability of the centralized management system 110 to deliver the content stream directly to the electronic device 102 allows the user to select only the programming that the user desires.

In an embodiment of the present disclosure, the user may select to receive television shows from multiple different channels. These television shows are delivered in the subscription-based content stream from the centralized management system 110 to the electronic device 102. The user may then view the television shows as if they were all broadcast on a single channel. In this sense, the user is able to watch a “virtual channel” of programming selected by the user. Thus, it will be appreciated that the user can select to receive sporting events, movies, television shows, news broadcasts, music, talk radio shows, or any other programming available from the centralized management system 110.

The centralized management system 110 may not be limited to any one content source and could offer content from a wide variety of content sources, including television networks, movie studies, radio stations, and even independent content sources. In an embodiment of the present disclosure, the centralized management system 110 may allow a user to select to receive programming in a native language of the user that would otherwise be unavailable. Further, the subscription-based content stream may be provided to the centralized management system 110 by an outside content source 120 over a communication path 122. It will be appreciated that the centralized management system 110 may receive the subscription-based content stream from a multiple outside content sources, including content source 104. Thus, the present disclosure allows programming that would not otherwise merit a dedicated “channel” to be delivered to the electronic device 102.

The present disclosure also allows for advertisements to be placed in relation to the subscription-based content streams. In an embodiment of the present disclosure, advertisements may be placed into the subscription-based content streams at the centralized management system 110. The subscription-based content streams and advertisements are subsequently transmitted to the electronic device 102 together. In another embodiment, the advertisements may be placed into the subscription based content streams at the electronic device 102. Thus, in this embodiment, the subscription-based content stream and the advertisements may be separately transmitted to the electronic device 102 by the centralized management system 110.

The advertisements placed into the subscription-based content stream may be targeted to a specific user of the electronic device 102. Alternatively, the advertisements may be placed into the subscription-based content stream based upon some other criteria, or even no criteria at all. Thus, if a user selects to receive specific content stream, e.g., a television show, from the centralized management system 110, the content stream would be rendered at the electronic device 102 with the advertisements added at the centralized management system 110 or at the electronic device 102.

The electronic device 102 may report feedback to the centralized management system 110 over the communication path 108. The feedback may include an electronic notification reporting that one or more targeted advertisements transmitted by the centralized management system 110 to the electronic device 102 has in fact been rendered to the targeted user. This feedback may allow the centralized management system 110 to track the delivery of the targeted advertisements. In addition, the feedback may include information on the content stream into which the targeted advertisement was placed. This information may be utilized by the centralized management system 110 to identify a provider of the content stream. As will be explained in more detail hereinafter, the provider of the content stream may share any advertising revenues generated from the placement of the targeted advertisement.

As previously mentioned, in an embodiment of the present disclosure, if a user of the electronic device 102 is found to have a profile that corresponds to a target profile for a targeted advertisement, the centralized management system 110 may deliver the targeted advertisement to the electronic device 102 via the communication path 108. In an embodiment of the present disclosure, if a user of the electronic device 102 is found to have a profile that corresponds to the target profile for the targeted advertisements, the centralized management system 110 may deliver the targeted advertisements to the electronic device 102 along with a subscription-based content stream via the communication path 108.

The targeted advertisements, and, if transmitted, the subscription-based content stream, may be stored in a storage medium locally associated with the electronic device 102. In response to determining that the targeted user is actually using the electronic device 102, the electronic device 102 may render the targeted advertisement to the user at the first available opportunity or some at other specified opportunity. The determination that the targeted user is actually using the electronic device 102 may be accomplished through a biometric or non-biometric recognition technique using the reference sample submitted by the user during the enrollment process.

The rendering of the targeted advertisement to a targeted user may be accomplished in several ways. In an embodiment of the present disclosure, upon verification that a targeted user is actually using the electronic device 102, the electronic device 102 may begin monitoring the content stream from the content source 104 or the subscription based content stream from the centralized management system 110 for advertisement placement opportunities. When an advertisement placement opportunity is identified, the electronic device 102 will render the targeted advertisement in accordance with the advertisement placement opportunity.

Further, the electronic device 102, either separately or in combination with the centralized management system 110, may also identify the owner or provider of the content stream or subscription-based content stream into which the targeted advertisement is placed. This information may be stored for later transmission to the centralized management system 110. Alternatively, the electronic device 102 may gather data regarding the content stream into which a targeted advertisement has been placed such that the data may be used to identify the owner or provider of the content stream. Thus, included in the communications 108 from the electronic device 102 to the centralized management system 110 may be information regarding the content stream into which the targeted advertisement is placed. Further, as previously mentioned, the electronic device 102 may send an electronic notification reporting that one or more of the targeted advertisements previously transmitted to the electronic device 102 by the centralized management system 110 has in fact been rendered to the targeted user. To the extent not previously provided, the centralized management system 110 may determine the content owner or content provider associated with the content stream from information received from the electronic device 102 over communication path 108.

The centralized management system 110 may send communications over a communication path 116 to a third-party system 118 operated by a content owner or content provider associated with the content stream from the content source 104. This information may include a report regarding the placement of the targeted advertisement into the content stream. The report may also include information on the sharing of any advertisement revenues generated by the advertisement placement as will be explained hereinafter.

In addition, the communications between the centralized management system 110 and the advertisement source 112 may include a report regarding the placement of the targeted advertisement. Likewise, the communications between the centralized management system 110 and the content source 120 may include a report regarding the placement of the targeted advertisement.

Although only one advertisement source 112 is depicted in FIG. 1, it will be appreciated by those having ordinary skill in the art that the centralized management system 110 may receive targeted advertisements from multiple advertisement sources. In this manner, the centralized management system 110 is able to deliver targeted advertisements from multiple advertisement sources. Further, it will be appreciated by those having ordinary skill in the art, that multiple users may enroll with the centralized management system 110 for the electronic device 102.

Moreover, although only one electronic device 102 is depicted in FIG. 1, it will be appreciated by those having ordinary skill in the art that multiple electronic devices, each having one or more users, may receive targeted advertisements from the centralized management system 110. In this manner, the centralized management system 110 is able to deliver targeted advertisements across multiple platforms to multiple users as will be explained in greater detail hereinafter.

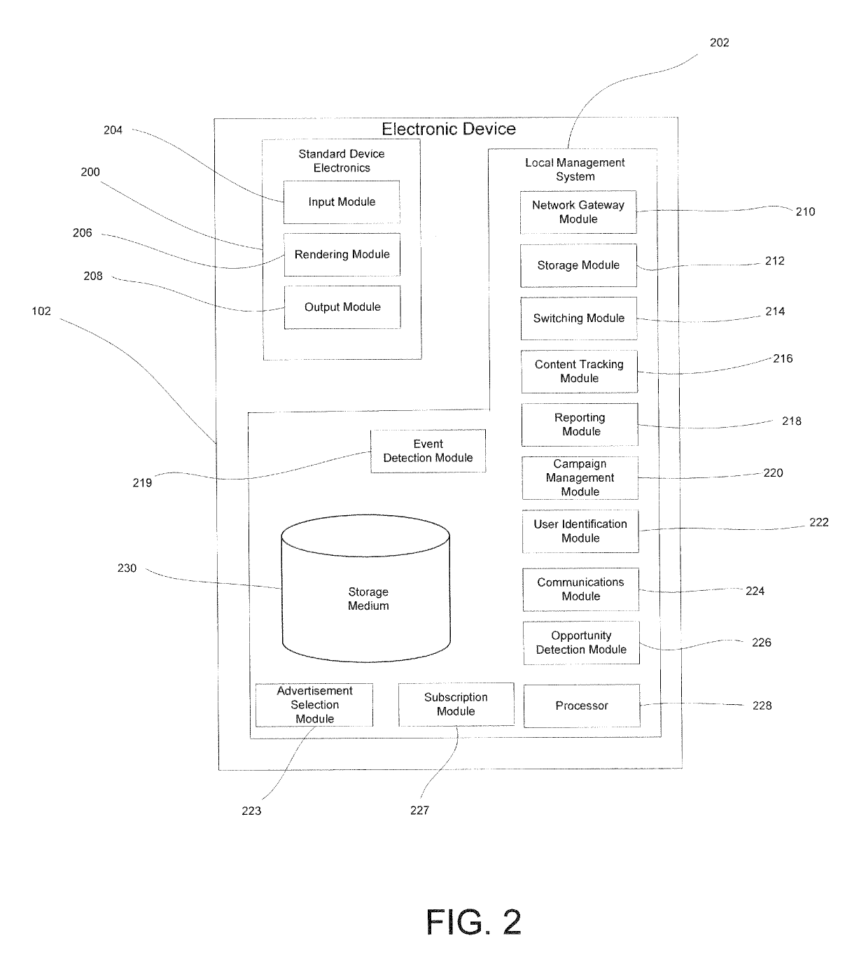

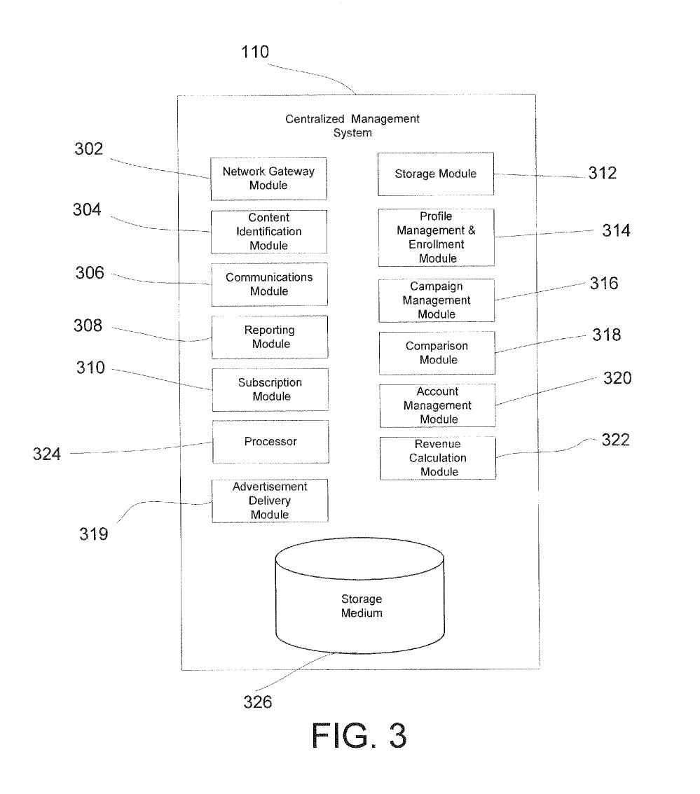

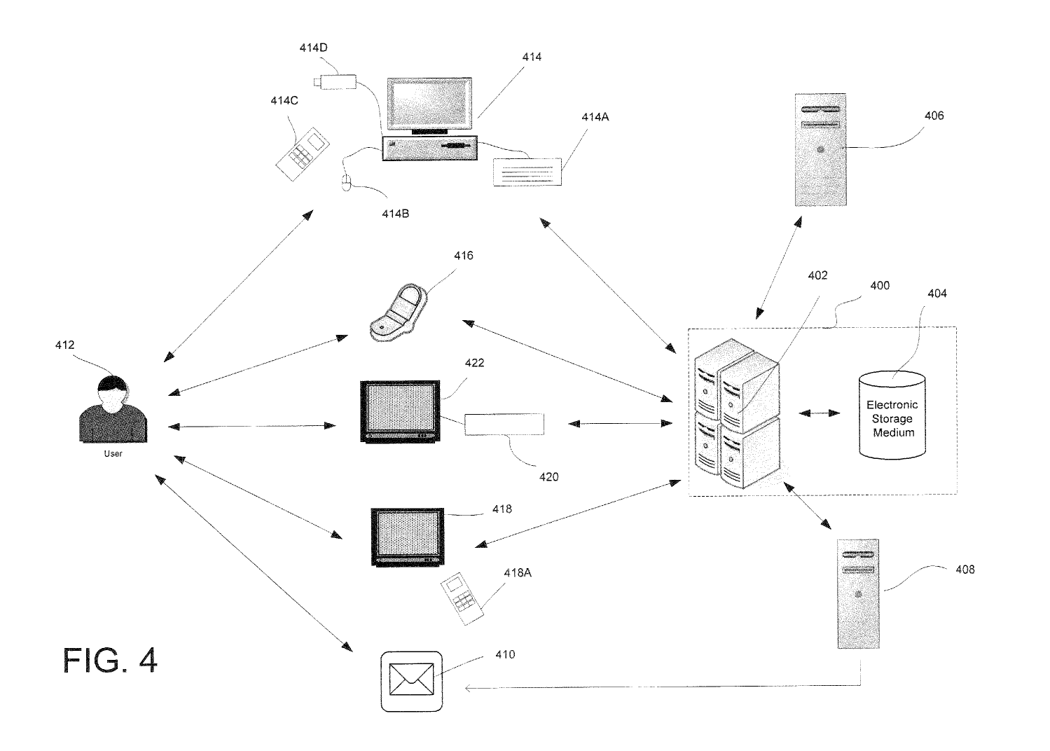

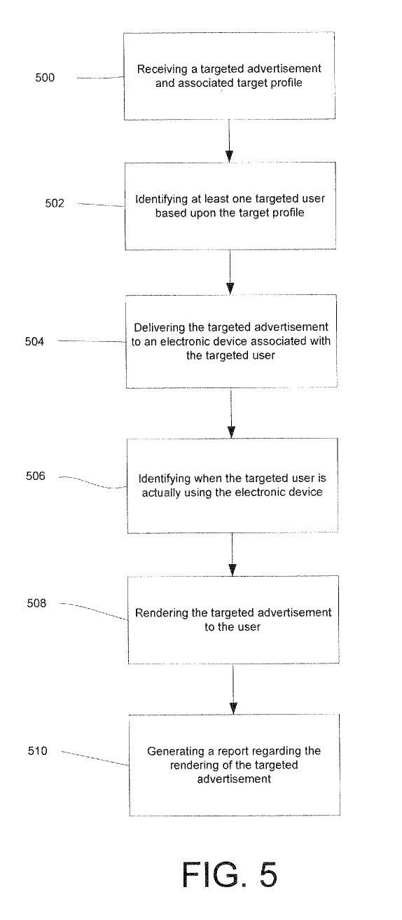

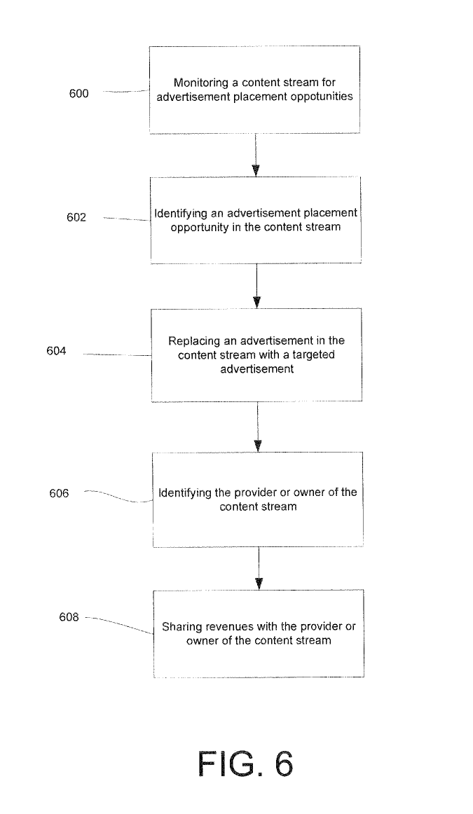

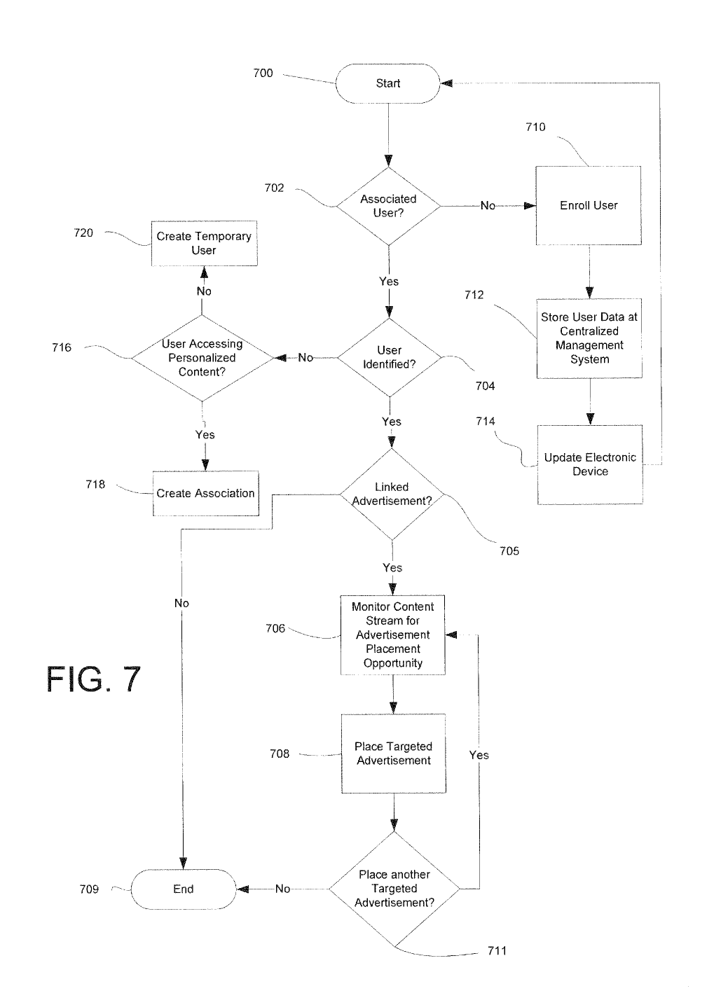

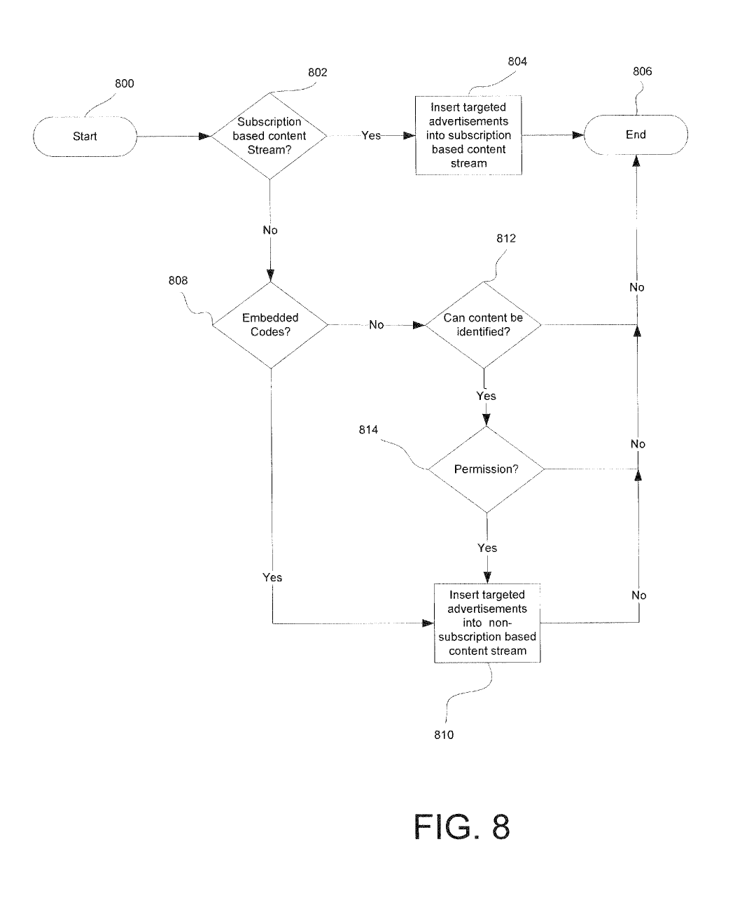

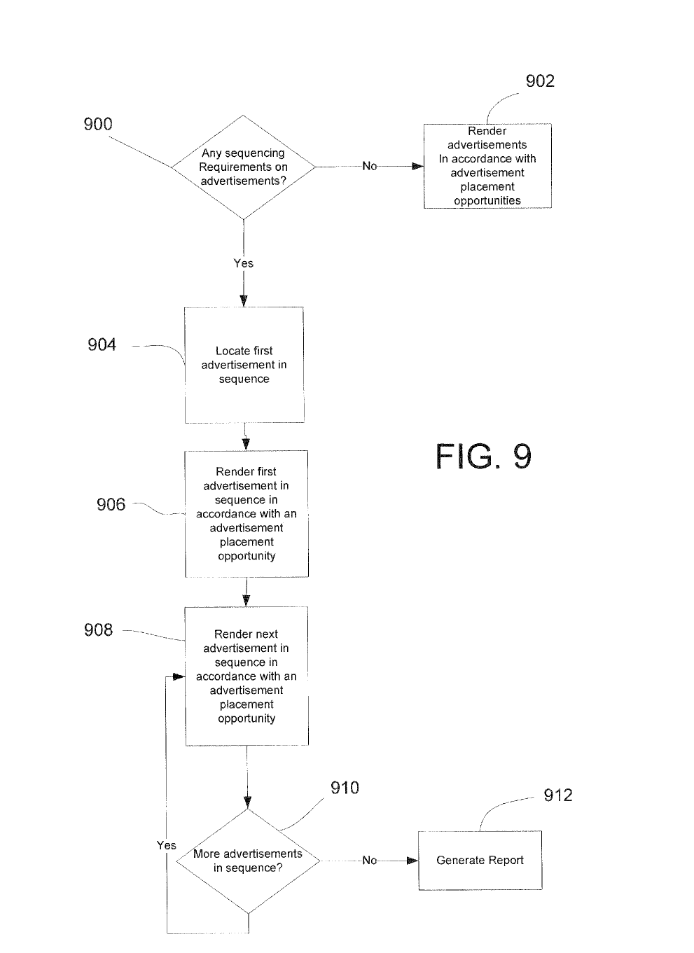

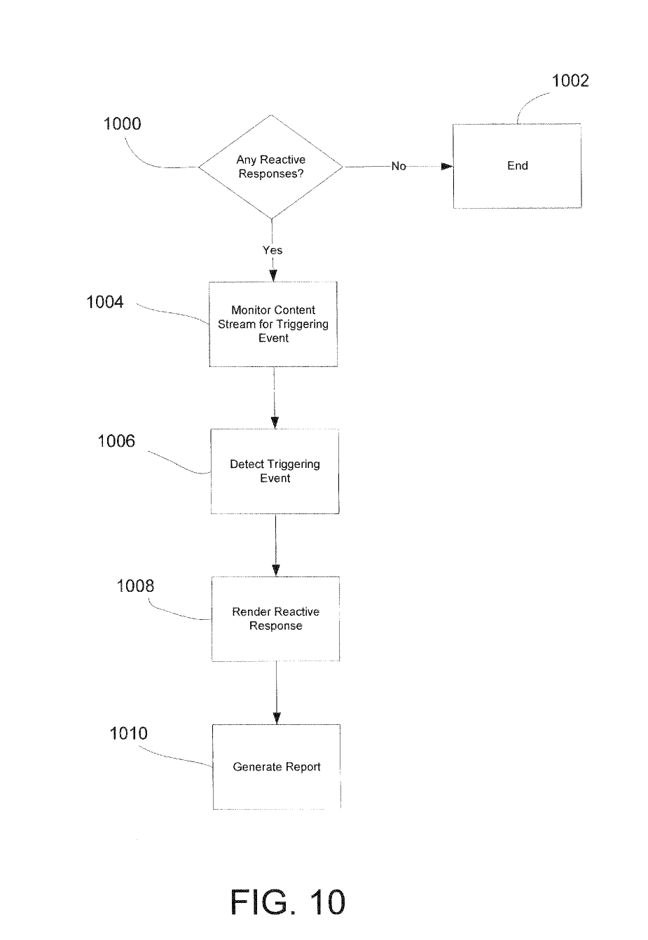

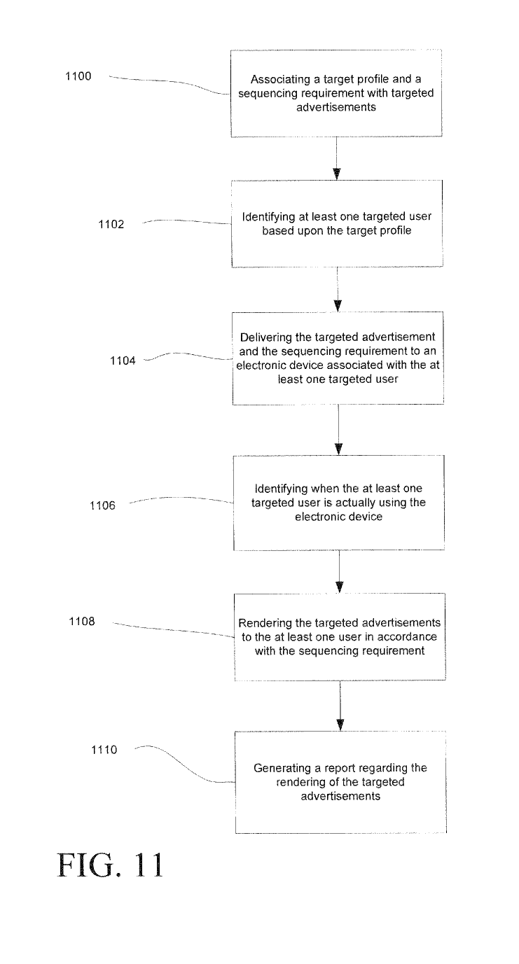

Referring now to FIG. 2, there is illustrated a diagram of the logical and other components of the electronic device 102 pursuant to an embodiment of the present disclosure. As previously mentioned, the present disclosure is not limited to any particular type of electronic device 102. An electronic device 102 may comprise, without limitation, televisions, cellular phones, computers, personal digital assistants and portable music players. Thus, it is to be understood by those having ordinary skill in the art that the features disclosed in relation to FIG. 2 may be incorporated into a wide range of electronic devices having the ability to render a content stream.

The electronic device 102 may include standard device electronics 200 and a local management system 202. The standard device electronics 200 may be those components typically associated with the type of electronic device 102. For example, if the electronic device 102 is a television, then the standard device electronics 200 may include those components typically found in a conventional television. Likewise, if the electronic device 102 is a computer, then the standard device electronics 200 may include those components typically found in a conventional computer. Additionally, if the electronic device 102 is a cellular phone, then the standard device electronics 200 may be those components typically found in a cellular phone.

In an embodiment of the present disclosure, the standard device electronics 200 may include an input module 204, a rendering module 206, and an output module 208. The input module 204 may be operable to receive a signal carrying a content stream from the content source 104 and may comprise all the necessary circuitry and related software to accomplish this task as is known to one having ordinary skill in the art. For example, if the content stream is received via a wireless connection, then the input module 204 may include an antenna and associated radio frequency circuitry, including a radio receiver chipset, necessary to receive the signal. Likewise, if the content stream is received via a wired connection, the input module 204 may include the appropriate connection jacks and the necessary circuitry and software to accomplish this task. The input module 204 may include a modem, a network card, and any other circuitry, hardware, decoder, and software necessary to receive the content stream.

The rendering module 206 may be operable to transform the content stream from the received form into an appropriate form compatible with the output module 208. The rendering module 206 may render at least one of digital and analog signals. The output module 208 may comprise a display, including an electronic display, screen, monitor, and/or speakers. The output module 208 may allow a user to actually perceive the content stream as rendered by the rendering module 206. It will be appreciated that the structure and apparatus disclosed herein is merely one example of a means for displaying an advertisement, and it should be appreciated that any structure, apparatus or system for displaying an advertisement which performs functions the same as, or equivalent to, those disclosed herein are intended to fall within the scope of a means for displaying an advertisement, including those structures, apparatus or systems for displaying an advertisement which are presently known, or which may become available in the future. Anything which functions the same as, or equivalently to, a means for displaying an advertisement falls within the scope of this element.

The local management system 202 may include the various modules as will now be described. A network gateway module 210 may be operable to allow communications between the electronic device 102 and the centralized management system 110. In an embodiment of the present disclosure, the network gateway module 210 may comprise a connection to a LAN or a WAN. In an embodiment of the present disclosure, the network gateway module 210 may allow communications to be received and transmitted over a network, such as the Internet. In particular, the network gateway module 210 may facilitate the communications with the centralized management system 110 over the communication path 108 (see FIG. 1).

The advertisements may be received through the network gateway module 210. In addition, any commands to regulate the rendering of the advertisements may be received through the network gateway module 210. In an embodiment of the present disclosure, the network gateway module 210 and the input module 204 may share components if the communication paths between the content source 104 and the centralized management system 110 are the same. In an embodiment of the present disclosure, the network gateway module 210 may comprise at least one of a modem, a network card and a high speed Internet connection.

The storage module 212 may be operable to control the storage of information in a digital storage medium 230 and may include the appropriate software and hardware drivers to effectuate the same. The information stored on the storage medium 230 may include advertisements and one or more content streams, as well as any other needed information or computer programming required to accomplish the tasks described herein.

It will be appreciated that the structure and apparatus disclosed herein is merely one example of a means for electronically storing an advertisement, and it should be appreciated that any structure, apparatus or system for electronically storing an advertisement which performs functions the same as, or equivalent to, those disclosed herein are intended to fall within the scope of a means for electronically storing an advertisement, including those structures, apparatus or systems for electronically storing an advertisement which are presently known, or which may become available in the future. Anything which functions the same as, or equivalently to, a means for electronically storing an advertisement falls within the scope of this element.

A switching module 214 may be operable to cause that the advertisements received from the centralized management system 110 are rendered on the electronic device 102 according to advertisement placement opportunities. In an embodiment of the present disclosure, the switching module 214 may comprise a switch capable of switching between the content stream from the content source 104 and the advertisements stored on the storage medium 230. Thus, the switching module 214 may dynamically switch back and forth the source for the rendering module 206 between the content stream from the content source 104 and the advertisements, which may be stored locally at the electronic device 102.

It will be appreciated that the structure and apparatus disclosed herein is merely one example of a means for switching between a content stream and an advertisement, and it should be appreciated that any structure, apparatus or system for switching between a content stream and an advertisement which performs functions the same as, or equivalent to, those disclosed herein are intended to fall within the scope of a means for switching between a content stream and an advertisement, including those structures, apparatus or systems for switching between a content stream and an advertisement which are presently known, or which may become available in the future. Anything which functions the same as, or equivalently to, a means for switching between a content stream and an advertisement falls within the scope of this element.

A content tracking module 216 may track and record information regarding the content stream into which the advertisements are placed. In an embodiment of the present disclosure, the content tracking module 216 may extract and record embedded codes in the content stream from the content source 104. These embedded codes may then be transmitted to centralized management system 110 where the content provider and/or content owner of the content stream from the content source 104 may be identified using the codes. In another embodiment, the content tracking module 216 may also simply track and record the time and the specific channel that carries the content stream. This information may then be transmitted to the centralized management system 110 where the content provider and/or content owner may be identified.

In an embodiment of the present disclosure, the content tracking module 216 may record the internet address of a website into which the advertisements are placed. This information may then be transmitted to the centralized management system 110. In an embodiment of the present disclosure, the content tracking module 216 may also create a map of the data in the content stream. The map of the data may then be transmitted to the centralized management system 110 where the content provider and/or content owner may be identified using the data map. It will be appreciated by those having ordinary skill in the art that any process or methodology now known or known in the future that is used to identify the owner or provider of a content stream falls within the scope of the present disclosure. A reporting module 218 may generate feedback and other information transmitted to the centralized management system 110. The feedback may include, for example, information verifying the rendering of a targeted advertising to the targeted user.

An event detection module 219 may monitor the content stream from the content source 104 for an occurrence of a predetermined triggering event. After the event detection module 219 has recognized an occurrence of the predetermined triggering event in the content stream, a reactive response may be dynamically rendered to a user of the electronic device 102 in accordance with the next available advertisement placement opportunity. Upon the detection of an occurrence of a predetermined triggering event, the event detection module 219 may inform a campaign management module 220. The campaign management module 220 may then cause the reactive response to be dynamically rendered in the content stream by, for example, replacing an original advertisement in the content stream. It will be noted that this process may require the use of the other modules described herein.

The campaign management module 220 may further insure that the targeted advertisements are rendered according to any advertisement sequencing requirements received from the centralized management system 110. The sequencing requirements may specify an order or pattern in which the advertisements are to be rendered to a user. For example, perhaps an advertiser has created a campaign in which Advertisement A needs to be shown first, Advertisement B second, and so on until Advertisement D. The campaign management module 220 may be operable to render the advertisements in accordance with these sequencing requirements. It will be appreciated that any sequencing requirements may include a number of different patterns, including, but not limited to ABCD, AABBCCDD, AABBCDD, ADABDACD, etc., where each letter represents a unique advertisement. In addition, the sequencing requirements may specify a delivery time range in which the entire sequence should be rendered or started. Further, advertisements may be repeated in a sequence multiple times to maximize effectiveness before proceeding to the next advertisement in the sequence. Typically, a sequence has a first advertisement and at least one next advertisement. The next advertisement may not be rendered to a user until the first or previous advertisement has been rendered. The sequencing requirements may be received from the centralized management system 110 over the communication path 108.

As mentioned above, the campaign management module 220 may be further able to place reactive responses as determined by the occurrence of a predetermined triggering event. A reactive response may include programming, content, or advertisements that may be renderable on the electronic device 102 to a user. A triggering event may include the presence of specific programming, content or advertisements in the content stream received from the content source 104. As discussed above, the event detection module 219 may monitor an incoming content stream for an occurrence of a triggering event. Once the event detection module 219 recognizes the occurrence of a triggering event in a content stream, the reactive response may be rendered to a user. The reactive response may be rendered in accordance with the next advertisement placement opportunity. For example, the event detection module 219 may monitor a content stream for a political ad of an opponent. The rendering of the political ad of the opponent to a user may trigger the subsequent rendering of the reactive response, which may be a counter political ad, to the user.

A user identification module 222 may be operable to identify the user of the electronic device 102. The user identification module 222 may incorporate integrated technologies that passively identify a user of the electronic device 102. As used herein, the term “passively” means that a user is not actively aware of the operation of the user identification module 222 or that the electronic device 102 does not require a specific user input to trigger the delivery of any targeted advertisements. In an embodiment of the present disclosure, the user identification module 222 may utilize a biometric recognition technologies and techniques. Suitable biometric recognition technology may include fingerprint recognition, retina recognition, heartbeat recognition, voice recognition, face recognition, and any other technology now known or known in the future that utilizes a measurable, physical characteristic or personal behavioral trait that may be used to recognize the identity, or verify the claimed identity, of a user. Other passive identification options for non-biometric technologies and techniques include associating a specific user with a cellular phone number, a serial number of an electronic device, or IP address assigned to an electronic device. The user identification module 222 may then identify a user based on the proximity of a known user mobile device associated with a specific cellular phone number, serial number, or IP address. The user identification module 222 may also use active identification technologies such as passwords, logins, and challenge questions to identify the user.

In the case where the user identification module 222 employs a biometric recognition technology, prior enrollment by the user may be required. That is, a user may be required to submit a reference sample of the characteristic or trait used to identify the user as previously described. Once taken, the reference sample may be stored at the centralized management system 110 or locally in the storage medium 230. The reference sample may be disseminated to the electronic device 102 associated with the user through the communication path 108. It will be appreciated that the reference sample for a user may be disseminated to multiple electronic devices 102 such that the user may only have to provide the sample one time.

The user identification module 222 may include the necessary components to capture the user's characteristic or trait. For example, in the case where the biometric technology utilizes finger print recognition, the user identification module 222 may include a fingerprint scanner. Once the user's fingerprint is scanned, the scan is compared to the reference sample to thereby identify the user.

Once a user's identity is determined, or, stated another way, the user of the electronic device 102 is determined to have previously enrolled with the centralized management system 110, an advertisement selection module 223 may determine if any targeted advertisements stored in the storage medium 230 are linked to that user. If a targeted advertisement is linked to the current user of the electronic device 102, then the advertisement selection module 223 may then notify the switching module 214 and an opportunity detection module 226 that a targeted advertisement needs placement. If there are no targeted advertisements, the advertisement selection module 223 may not take any action. As discussed above, the rendering of targeted advertisements may be optionally subject to sequencing requirements as determined by the rendering management module 220.

A communications module 224 may be operable to control communications between the electronic device 102 and the centralized management system 110 through the network gateway module 210.

As discussed, the opportunity detection module 226 may be operable to recognize advertisement placement opportunities in relation to a content stream from the content source 104. For example, the opportunity detection module 226 may identify an advertising placement opportunity in a content stream for an advertisement received from the centralized management system 110. In order to identify an advertisement placement opportunity, the opportunity detection module 226 may monitor the content stream for embedded codes that signal an upcoming “time slot” designated for advertising. The embedded codes may take the form of an inaudible tone or any other type of signaling or flag. Once an upcoming slot designated for advertising has been identified, the opportunity detection module 226 may cause that the original advertisements in the content stream be displaced by the targeted advertisements received from the centralized management system 110 using the switching module 214. If the content stream is HTML coding that defines a webpage, the opportunity detection module 226 may cause a banner ad in the content stream to be swapped with an advertisement, also a banner ad, from the centralized management system 110.

It will be appreciated that the structure and apparatus disclosed herein is merely one example of a means for determining an advertisement placement opportunity for the advertisement, and it should be appreciated that any structure, apparatus or system for determining an advertisement placement opportunity for the advertisement which performs functions the same as, or equivalent to, those disclosed herein are intended to fall within the scope of a means for determining an advertisement placement opportunity for the advertisement, including those structures, apparatus or systems for determining an advertisement placement opportunity for the advertisement which are presently known, or which may become available in the future. Anything which functions the same as, or equivalently to, a means for determining an advertisement placement opportunity for the advertisement falls within the scope of this element.

A subscription module 227 may manage the subscription-based content stream from the centralized management system 110. The subscription module 227 may be operable to generate a graphical user interface to allow a user to select individualized content or programming available from the centralized management system 110. In this regard, the centralized management system 110 may transmit to the electronic device 102 over the communication path 108 a list of all available content and programming, which is then displayed by the subscription module 227 to a user.

The local management system 202 may also include a microprocessor 228, also known as a centralized processing unit. As the various modules 210-227 may include computer programming code to accomplish the features as described herein, the modules 210-227 may utilize the microprocessor 228 to accomplish their intended purposes as outlined herein. In an embodiment of the present disclosure, the microprocessor 228 may be incorporated into the modules 210-227.

It will be appreciated that the local management system 202 may be integrated into the electronic device 102 or may be contained in a separate and stand-alone unit having a connection to the electronic device 102, i.e., the standard device electronics 200. It will further be noted that any of the modules 210-227 may also be integrated into the electronic device 102, or any or all of them may be externally located with respect to the electronic device 102. Further, an omission of one or more of the modules 210-227 in an electronic device 102 still falls within the scope of the present disclosure. That is, embodiments of the present disclosure may have less than all of the modules 210-227 shown in FIG. 2. Further, the modules 210-227 may share common resources, including software and hardware, without departing from the scope of the present disclosure.

Referring now to FIG. 3, there is illustrated a diagram of the logical and other components of an exemplary embodiment of a centralized management system 110. As mentioned above, the centralized management system 110 may be remotely located from the electronic device 102 such that the centralized management system 110 is able to communicate with a plurality of electronic devices over a network. Indeed, it will be appreciated the centralized management system 110 may connect to thousands or millions of electronic devices via one or more networks. Various components of the centralized management system 110 will now be described.

A network gateway module 302 may be operable to allow communications between the electronic device 102 and the centralized management system 110. The network gateway module 302 may provide a connection to a network, such as a LAN or a WAN. In an embodiment of the present disclosure, the network gateway module 302 may allow communications to be received and transmitted over a network, such as the Internet or a proprietary network. The network gateway module 302 may also allow communications with the advertisement source 112 and the third-party system 118 as described herein.

A content identification module 304 may be operable to identify the content provider and/or the content owner of a content stream into which an advertisement is placed by the electronic device 102. The content identification module 304 may use information gathered by the content tracking module 216 of electronic device 102 and transmitted to the centralized management system 110 in order to identify the content provider and/or content owner of the content stream. The content identification module 304 may identify the content provider and/or content owner of the content stream using any one of a variety of methods described below.

In an embodiment of the present disclosure, a content provider and/or content owner of the content stream may be identified using codes embedded in the content stream. The embedded codes may be extracted from the content stream by the electronic device 102. Once extracted, the codes may then be transmitted to the centralized management system 110 using communication path 108. The content identification module 304 may then use the codes to properly identify the content provider and/or content owner of the content stream. Alternatively, the content identification module 304 may utilize a data point map extracted from the content stream and transmitted to the centralized management system 110 by the electronic device 102. The content identification module 304 may then compare this map to known maps to identify the content owner and/or content provider. In another embodiment, the electronic device 102 may log the time and channel on which the content stream is broadcast and transmit this information to the centralized management system 110. The content identification module 304 may then compare this information to a programming schedule to identify the content owner and/or content provider.

A communications module 306 may be operable to control communications between the electronic device 102 and the centralized management system 110, the centralized management system 110 and the advertisement source 112, and the centralized management system 110 and the third-party system 118. For example, the communications module 306 may identify preferred communication times to download the advertisements to the electronic device 102. The communication module 306 may track successful and unsuccessful communications and repeat as necessary. The communication module 306 may be completely autonomous from human interaction such that the communications with the electronic device 102 occur automatically. The communications module 306 may send the communications through the network gateway module 302.

A reporting module 308 may be operable to generate reports regarding the advertisement placing and any revenue sharing with those content providers identified by the content tracking module 304. The reports may be generated automatically pursuant to a reporting policy established by the operators of the centralized management system 110. The reports generated by the reporting module 308 may include information received from the reporting module 218 on the electronic device 102.

A subscription module 310 may be operable to provide a subscription-based content stream having customized content to the electronic device 102. For example, as explained previously, a user of the electronic device 102 may be able to interactively select programming and other content for delivery to the electronic device 102 from the centralized management system 110. Targeted advertisements may be placed into the subscription-based content stream at the centralized management system 110 prior to transmission to the electronic device 102. This may be done on-the-fly as the subscription-based content stream is transmitted. Alternatively, the subscription-based content stream may be transmitted separately from the targeted advertisements. Thus, the subscription module 310 that is operable to allow a user to subscribe to any content stream available from the centralized management system 110. As mentioned, the content stream may be provided by an outside content source 120 over the communication path 122 to the centralized management system 110. It is contemplated that the present disclosure includes receiving content streams from multiple content sources.

The subscription module 310 may provide a list of all available content streams to the electronic device 102 to thereby facilitate user selection at the electronic device 102. The subscription module 310 may provide navigable menu screens to the electronic device 102 such that the user may select from available programming. For example, the screens may include all available movies, shows, programming or other content available for delivery to the electronic device 102 through the centralized management system 110. As discussed above, the content for the subscription-based content stream may be provided to the centralized management system 110 by an outside content source 120 over a communication path 122 (see FIG. 1).

The centralized management system 110 may include a storage module 312 that is operable to manage and control the storage of information in a storage medium 326. The storage module 312 may include a database management application suitable for the purposes outlined herein. The storage module 312 may include the appropriate software drivers for accessing information from the storage medium 326.

The centralized management system 110 may include a user profile management and enrollment module 314 that may be operable to receive and manage user profiles in the storage medium 326. A user profile may include demographic information regarding a user of the electronic device 102. The user profile management and enrollment module 314 may administer an on-line profile assessment to a user thereby enroll a user with the centralized management system 110. The user profile management and enrollment module 314 may also receive and store biometric reference samples from users as part of the users profile. In addition, the user profile management and enrollment module 314 may also associate all of the electronic devices of a user with the user's profile.

The centralized management system 110 may also include a campaign management module 316 that is operable to manage and control an advertising campaign and to set and define any sequencing requirements for the targeted advertisements. An advertising campaign may include various phases. Each phase may include the delivery of an advertisement using a different platform. Using feedback from the electronic device 102, the campaign management module 316 may cause subsequent phases of an advertising campaign to be performed on a different platform or the same platform in a sequential manner.

As discussed above, the sequencing requirements may specify an ordered sequence or pattern in which advertisements are to be presented to a user of the electronic device 102. The sequencing requirements may be provided by the advertisement source 112 to the centralized management system 110 along with the advertisements. Further, the sequencing requirements may specify a time range in which a sequence of advertisements is to be rendered to a user to maximize the effectiveness of the advertisements. The advertisement source 112 may be charged a premium of utilizing the sequencing feature of the present disclosure for advertisement delivery. Once the centralized management system 110 has received the sequencing requirements, the sequencing requirements are associated with the appropriate targeted advertisements and transmitted to the electronic device 102.

For example, the advertisement source 112 may request that a sequence of advertisements be delivered to all users enrolled with the centralized management system 110 whose user profiles meet the following criteria: male, 20-25 year old, college degree, 2 children under 10 years of age, and at least a $40,000 income. Furthermore, the advertisement source 112 may request that the advertisements be rendered to the users in a predetermined sequence and over a defined period of time. The centralized management system 110 may then transmit the advertisements and the sequencing requirements to electronic devices 102 whose users have a matching profile as specified by the advertisement source 112. The electronic devices 102 may then rendered the advertisements to the users thereof in the predetermined sequence. In this manner, the present disclosure may be able to control the sequence in which targeted advertisements are rendered to targeted users.

The campaign management module 316 may be further operable to allow a reactive response to be rendered to users in response to predetermined triggering event. A reactive response may include any programming, content, advertisements that are renderable on the electronic device 102. A triggering event may include a user being exposed to pre-specified programming, content, or advertisements on the electronic device 102. Typically, the advertising source 112 that provides the reactive response identifies the correct triggering event to the centralized management system 110. For example, if the provider of the reactive response is a political campaign, the triggering event may include the occurrence of a political ad of an opponent in a content stream received by the electronic device 102. In this example, the reactive response may include a political advertisement countering statements in the opponent's advertisement in the content stream. Once received at the centralized management system 110, the triggering event and the reactive response are transmitted to the electronic device 102. As explained previously, the electronic device 102 may monitor an incoming content stream from the content source 104 for an occurrence of the triggering event. Once the triggering event is detected, the electronic device 102 may render the reactive response to a user at the next advertisement placement opportunity. In this manner, the present disclosure is able to provide reactive responses to content, programming, or advertisements seen by a user.

The centralized management system 110 may include a comparison module 318 that is operable to compare the target profiles for any targeted advertisements to the user profiles to thereby determine a group of targeted users. At this point, the centralized management system 110 may generate feedback to the advertisement source 112 regarding the group of targeted users. This feedback may include the information regarding the number of users in the group of targeted users. This information may allow the modification of the target profile such that the size of the group of targeted users may be increased or decreased. This process may undergo several iterations until a desired group of targeted user profiles has been generated.

Once the targeted users have been identified and finalized by the comparison module 318, the centralized management system 110 may disseminate the targeted advertisements to an electronic device 102 associated with each of the targeted users via the advertisement delivery module 319. The advertisement delivery module 319 may also transmit a link associated with a targeted advertisement. The link may identify the targeted user to whom the targeted advertisement is to be directed. In this manner, the electronic device 102 may utilize the link to ensure proper delivery of the targeted advertisement to the targeted user.

It should be noted that users who do not have a matching profile to the targeted profile may not receive the targeted advertisements. The dissemination of the targeted advertisements to the electronic devices 102 of the targeted users may take place as the system demands allow. Typically, this may occur during off-peak hours. Further, the process may occur over several hours, days or weeks depending upon the size of the group of targeted users.

An account management module 320 may be operable to establish and manage accounts for content providers and advertisement providers. The account management module 320 may establish a revenue account for the content providers. The revenue accounts of each of the content providers may be updated to reflect the content providers share of any advertising revenues generated from the placement of the targeted advertisements in relation to a content stream associated with the content providers. The content providers may provide the content streams directly to the centralized management system through content source 120 or to directly to the electronic device 102 through content source 104. Thus, the present disclosure is able to compensate content providers for the replacement of advertisements in content streams with the targeted advertisements.

A revenue calculation module 322 may be operable to calculate any revenue sharing of any compensation received for placing the targeted advertisements. Compensation for placing the targeted advertisement may be received from the operators of the advertising source 112, which may include advertising agencies or companies. It will be appreciated that because the present disclosure may be able in most cases to identify the content provider of the content stream into which the targeted advertisements are placed, that the operators of the centralized management system 110 are able to share revenues with the content provider of the content stream.

Further, the revenue calculation module 322 may generate a report that is transmitted to the third-party system 118, which may be operated by the content providers of the content stream. The revenue calculation module 322 calculates the revenue sharing based upon the particular content stream into which a targeted advertisement is placed. For example, if the electronic device 102 is a television tuned to a broadcast television station showing a movie, the electronic device 102 may insert a targeted advertisement into the movie during a regularly scheduled commercial break. The electronic device 102 may record the time that the targeted advertisement was placed and the channel showing the movie. This information may be transmitted back to the centralized management system 110. Using this information, the centralized management system 110 may then identify the content provider, i.e., the broadcast television station, and the content owner, i.e., the owner of the movie being broadcast (such as a movie studio). The revenue calculation module 322 may then calculate shares of the compensation received from an advertising agency to place the targeted advertisement among the operators of the centralized management system 110, and the content owner, and content provider. This model may require that the operators of the centralized management system 110 establish revenue sharing agreements with the content providers to determine the amount of the revenue share. As used herein, the term “content provider” shall be construed to also include content owners.

The centralized management system 110 may include a microprocessor 324, also known as a central processing unit, that is operable to process any of the required data from any of the modules 302-322. The processor 324 may take any one of a variety of forms including a single processor or multiple processors. The processor 324 may be included in one or more of the modules 302-322. Further, it will be appreciated that the centralized management system 110 may be integrated into a single computing device or may be distributed across multiple computing platforms. It will further be noted that the modules 302-322 may also be integrated into a single computing device or may be separately located amongst multiple computing platforms. Further, omission of one or more of the modules 302-322 falls within the scope of the present disclosure. That is, alternative embodiments of the present disclosure may have less than all of the modules 302-322 shown in FIG. 3.

Referring now to FIG. 4, there is shown an embodiment of the present disclosure. A centralized management system 400 may comprise one or more computing devices 402 in communication with an electronic storage medium 404. The centralized management system 400 may include a network gateway for communicating with other devices. The centralized management system 400 may receive targeted advertisements in an electronic format from a computing device 406. The computing device 406 and the centralized management system 400 may communicate over a computer network, such as the Internet. The computing device 406 may be operated by advertisers or advertising agencies. When received at the centralized management system 400, the targeted advertisements may be electronically stored in the electronic storage medium 404 where they can be accessed by the computing devices 402.

It should be noted that the targeted advertisements may stored in any format suitable for rendering on an electronic device. For example, suitable formats for the targeted advertisements may include AVI, Windows Media, MPEG-1, MPEG-2, MPEG-4, QuickTime, RealVideo, Flash and Shockwave. Other suitable formats may include audio formats such as AAC, AC3, MIDI, MP3, RealAudio, Waveform, and WMA. Other suitable formats may include image formats such as BMP, GIF, JPG, JPG 2000, MNG, PNG, SVG, TIFF. Other suitable formats may include ASCII, DOC, EBCDIC, HTML, OEBPS, RTF, Unicode, WPD, and XML. Still other suitable formats may include DVD, Blue-Ray, and HD DVD formats.

The computing device 406 may also transmit a target profile to the centralized management system 400 in association with the targeted advertisements. The target profile may specify a specific profile of the intended recipients of the targeted advertisements. The centralized management system 400 may compare the target profile to user profiles stored on the electronic storage medium 404 using a computer application running on computing devices 402. The comparison of the target profile to the user profiles may result in a list of targeted users for the targeted advertisements. Thus, it will be understood that the targeted users may have a profile that matches or is close to the requirements of the target profile. This list of targeted users may be stored on the electronic storage medium 404. The centralized management system 400 may be able to manage the delivery of the targeted advertisements across multiple platforms to targeted user as will be described in more detail below.

The centralized management system 400 may also able to communicate with a computing device 408. The computing device 408 may control a traditional advertising platform 410 such as direct mailers, electronic mail, or an outbound call center. The centralized management system 400 may direct the computing device 408 to initiate a phase of an advertising campaign through the traditional advertising platform 410 to the targeted users upon command. The centralized management system 400 may send the information, i.e., the particular advertisement to be used and the name and contact information of the targeted users, to the computing device 408 electronically. The centralized management system 400 may also control the timing of when the computing device 408 initiates the campaign through the traditional advertising platform 410. The computing device 408 may report back to the centralized management system 400 confirming the execution of the advertising through the traditional advertising platform 410.

A user 412 may enroll with the centralized management system 400 by completing a profile assessment. This may be accomplished via a graphical user interface, an online survey, a personal interview, or any similarly related methodologies to obtain profile information about the user 412. During the enrollment process, the user 412 may provide information relating to his or her profile, which is stored by the centralized management system 400 in the electronic storage medium 404. As mentioned previously, the profile of the user 412 may include information regarding the age of the user 412, the sex of the user 412, income of the user 412, marital and family status of the user 412, the race of the user 412, the native language of the user 412, the credit rating of the user 412, hobbies of the user 412, interests of the user 412, or any other helpful information that can be utilized to direct targeted advertisements to the user 412.

During the enrollment process, the user 412 may also provide a reference sample for biometric identification purposes. The reference sample may include a reference sample suitable for identifying the user 412 using any biometric recognition technology, including, without limitation, fingerprint recognition, retina recognition, heartbeat recognition, voice recognition, face recognition, and any other technology now known or known in the future that utilizes a measurable, physical characteristic or personal behavioral trait that may be used to recognize the identity, or verify the claimed identity, of a user. The user 412 may also be required to submit information for use with other personal identification technologies, such as passwords, logins, identification numbers, and challenge questions—all of which can be used to identify the user 412. This identification information may be stored at the centralized management system 400.

In return for enrollment with the centralized management system 400, the user 412 may be provided with one or more platforms through which advertisements and content may be rendered to the user 412. One or more of the platforms provided to the user 412 may be a type of electronic device with rendering capability. FIG. 4 illustrates examples of some of the suitable platforms in the form of electronic devices that may be provided to the user 412 in return for his or her enrollment with the centralized management system 400. The electronic devices provided to the user 412 may include a computer 414, a cell phone 416, and a television 418. In addition, the user 412 may be provided with an aftermarket box 420 for enabling a traditional television 422 to be used in accordance with the present disclosure.

Each of the computer 414, phone 416, television 418, and box 420, may have a network gateway for enabling two-way electronic communications with the centralized management system 400. These communications may occur over a network, such as the Internet. The centralized management system 400 may be able to deliver targeted advertisements to each of the computer 414, phone 416, the television 418, and the box 420 based upon the profile of the user 412. The targeted advertisements may be stored in a storage medium associated with each of the computer 414, phone 416, television 418, and the box 420 until needed. For this reason, it will be appreciated that a targeted advertisement may be transmitted in a format suitable for rendering on the particular electronic device to which it is sent. In this manner, the present disclosure is able to deliver advertisements across multiple platforms to the same user 412. Further, the centralized management system 400 may disseminate any necessary profile information such that positive identification of the user 412 may be ascertained.

The computer 414 may include a keyboard 414A, a mouse 414B, a remote control 414C and a camera 414D. One of the keyboard 414A, mouse 414B and the remote control 414C may each include a biometric sensor for determining the identification of the user 412. The biometric sensor may include, for example, a fingerprint scanner, heartbeat scanner, or a microphone used to capture the voice of the user 412. In one embodiment of the present disclosure, the identity of the user 412 is determined passively. For example, the fingerprint scanner may be located on a control button such that by using the control button, the fingerprint of the user 412 is automatically and passively captured. In another embodiment, the identity of the user 412 is captured actively. For example, the user 412 may be required to speak such that the voice of the user 412 may be captured for voice recognition. The camera 414D may be used to capture an image of the face of the user 412 for use with facial recognition techniques. The user 412 may also be prompted to enter a password that may be utilized to identify the user 412.

The television 418 may include a remote control 418A. The remote control 418A may include a biometric sensor, including, for example, a fingerprint scanner, a heartbeat scanner, or a microphone. In addition, a camera may be incorporated into the remote control 418A for enabling the use of facial recognition techniques. Once a biometric characteristic or trait is captured, the remote control 418A may transmit this information to the television 418. In addition, the remote control 418A may be used for content selection.

The box 420, attached externally to a conventional television 422, may also include a biometric sensor, including, for example, a fingerprint scanner, a heartbeat scanner, or a microphone. In addition, a camera may be incorporated into the box 420 for enabling the use of facial recognition techniques. The box 420 may use the information to identify the user 412. It will be appreciated that the use of the biometric recognition techniques allow for the positive identification of instances when the user 412 is actually using the electronic devices, namely the computer 414 and the televisions 418 and 422. Further, these recognition techniques ensure that the targeted advertisements are rendered to the user 412 and not some other person that happens to use any of the electronic devices shown in FIG. 4.

It will be appreciated, that each user of the electronic devices 414, 418, and 420 may be required to enroll with the centralized management system 400. For example, all of the members of a household may enroll with the system 400. In this case, targeted advertisements for each household member may be sent to the electronic devices 414, 418, and 420 shown in FIG. 4. Further, since the targeted advertisements are stored locally at each electronic device, the targeted advertisements may be rendered to the targeted user 412 when it is determined that the targeted user 412 is actually using the electronic device through the identification techniques described herein. In other words, a targeted advertisement may not be rendered until it is determined that the targeted user 412 is actually using the one of the electronic devices 414, 418, and 420 shown in FIG. 4.

The manner in which the targeted advertisements may be rendered to the user 412 will now be explained pursuant to an embodiment of the present disclosure. In regards to the computer 414, the targeted advertisements may be rendered to the user 412 any time that the user 412 is determined to be using the computer 414 through a biometric recognition technique or another identification technique as explained above. In addition, the computer 414 may receive an incoming content stream over a network from a content provider, such as an Internet service provider. An application operating on the computer 414 monitors the incoming content stream for targeted advertisement placement opportunities. The application may replace an advertisement in the content stream with a targeted advertisement directed to the user 412. For example, in the case where the content stream includes a banner ad, the application may replace the banner ad in the content stream, with a targeted advertisement banner ad. Thus the user 412 does not see the original banner ad, but only the targeted advertisement banner ad.

In an embodiment of the present disclosure, the incoming content stream may be monitored at a router level instead of at the computer 414. The advertisement replacement can then take place at the router level in the same manner as described above. In an embodiment of the present disclosure, the incoming content stream may first be routed through a proprietary server or gateway. The advertisement replacement may then take place at this proprietary server or gateway in the same manner as described above. Thus, it should be understood that advertisement placement into a content stream can take place at any point along the path of the content stream between the content provider and the electronic device which renders the content stream. Further, the targeted advertisement placement may even take place at the content provider prior to transmission.

As mentioned, the user 412 may never see the original banner ad transmitted in the content stream, since it is replaced with the targeted advertisement sent by the centralized management system 400. This placement process is facilitated by the fact that the target advertisements are stored locally on the device inserting the advertisement into the content stream, e.g., the computer 414, a router, gateway or proprietary server, as the case may be. It will be appreciated that the replacement of the original banner ad may comprise providing a link to the targeted banner ad, which may be stored locally on the computer 414 or at some other location. That is, the targeted banner ad may not necessarily be stored at the computer 414. In this scenario, the centralized management system 400 may provide the link information to the computer 414. The present disclosure may be able to replace other advertisements typically found on web pages and the like using the concepts explained herein. In addition, the targeted advertisements may be inserted into computer applications running on the computer 414. The computer applications may include computer games and the like.

In regards to the television 418, the targeted advertisements may be rendered to the user 412 anytime that the user 412 is determined to be watching the television 418 through a biometric recognition technique or another identification technique. For example, the biometric sensor on the remote control 418A may assist in identifying the user 412. The television 418 may have the necessary components for storing and rendering the targeted advertisements integrated into the television 418. The television 418 may also have the necessary components for communicating with the centralized management system 400 integrated therein. For example, the television 418 may incorporate one or more of the modules of the local management system 202 as shown in FIG. 2.

In an embodiment of the present disclosure, after the positive determination that the user 412 is using the television 418, the television 418 may immediately begin monitoring an incoming content stream for advertisement placement opportunities. The incoming content stream may include, without limitation, broadcast television signals, satellite signals, cable signals, IPTV signals, signals from gaming consoles (Xbox, Playstation, Nintendo), and signals from VCR, DVD, Blue-Ray, DVR, and HD DVD players. The advertisement placement opportunities may be recognized from embedded signals in the content stream, a programming schedule, or by any other means.

Once a targeted advertisement placement opportunity has been identified, a targeted advertisement directed specifically to the user 412 may be retrieved from a local storage medium and rendered to the user 412 in accordance with the next targeted advertisement placement opportunity. The targeted advertisement may be pre-buffered by the television 418 for nearly instantaneous rendering on the television 418. In order to render the targeted advertisement, the television may dynamically switch from rendering the content stream to rendering the targeted advertisement. Once the targeted advertisement has been rendered, the television 418 may switch back to rendering the content stream. The rendering of the targeted advertisement may involve displacing an advertisement in the incoming content stream. However, the user 412 typically will not know that an original advertisement in the content stream has been displaced by a targeted advertisement as it appears to be part of the normal content stream.

In regards to the television 422, it may not have the integrated components to store and render targeted advertisement to the user 412. The use of the stand-alone box 420, which has the components necessary for storing and rendering the targeted advertisements received from the centralized management system 400, may allow for the placement of the targeted advertisements in a manner similar to that described in relation to television 418. Further, the box 420 may include biometric recognition technologies for positively identifying when the user 412 is watching the television 422. It will be appreciated that the use of box 420 allows the present disclosure to be used with off-the-shelf consumer products, such as the television 422. The box 420 can be adapted to function with other types of electronic devices. The box 422 may include one or more of the modules associated with the local management system 202 depicted in FIG. 2 to thereby place a targeted advertisement in a content stream.

In regards to the cellular phone 416, the targeted advertisements may be rendered to the user 412 at anytime on a display of the phone 416. Further, the phone 416 may not require the use of a biometric recognition technology due the fact cellular phones typically do not have multiple users. Thus, it may be assumed that the user 412 is always the person using the phone 416. However, the use of a biometric recognition technology or other identification technique with a cellular phone is within the scope of the present disclosure. The targeted advertisements may be delivered over a cellular phone network that receives the targeted advertisements from the centralized management system 400. Prior to rendering, the targeted advertisement may be stored in a memory device of the phone 416. The cellular phone 416 may include one or more of the modules associated with the local management system 202 depicted in FIG. 2 to thereby place a targeted advertisement in a content stream.

Each of the electronic devices, i.e., computer 414, phone 416, television 418, and box 420 may report the rendering of a targeted advertisement to the user 412 back to the centralized management system 400. This report or feedback may be particularly useful in managing an advertising campaign directed to the user 412. For example, once it has been determined that a particular advertisement has been rendered to the user 412, using any one of the electronic devices, computer 414, phone 416, box 420, and television 418, the centralized management system 400 may implement another phase of an advertising campaign based upon the report. For example, the centralized management system 400 may implement a follow-up advertisement to the user 412 using a traditional advertising platform 410, e.g., a direct mailer, or cause the follow-up advertisement to be rendered on any of the electronic devices, computer 414, phone 416, box 420, and television 418. Using this delivery and reporting structure, the centralized management system 400 may be able to ensure that advertisements are rendered to the user 412 pursuant to a predetermined sequence. Further, the predetermined sequence of advertisements is not limited to a single electronic device for delivery. That is, a sequenced group of advertisements of an advertising campaign may be rendered in sequence to the user 412 across a plurality of platforms.

Likewise, the ability of the electronic devices illustrated in FIG. 4, i.e., the computer 414, phone 416, television 418, and box 420, to provide reports or feedback may allow for reports to be sent to computing device 406. Thus, if computing device 406 is operated by advertisers, the advertisers are able to track the progress of the placement of their targeted advertisements in virtually real-time. The same applies if the computing device 406 is operated by a content provider. Each of the electronic devices shown in FIG. 4, i.e., the computer 414, phone 416, television 418, and box 420 may also be able to identify the provider or owner of the content stream into which a targeted advertisement is placed. This content provider identification may be accomplished with or without the assistance of the centralized management system 400. In an embodiment of the present disclosure, the content provider identification occurs at the centralized management system 400. As previously discussed, this may be accomplished via embedded coding in the content stream. Alternatively, this may be accomplished via consulting a programming schedule or through mapping data points in the content stream and referring to a look-up table.

As mentioned, the identification of the user 412 may occur passively or actively through the integrated components of the electronic devices, i.e., the computer 414, phone 416, television 418, and box 420, shown in FIG. 4. The integrated components in the electronic devices shown in FIG. 4 may take the form of the components shown in relation to the local management system 202 shown in FIG. 2. Typically, the present disclosure captures the required identification data through the normal use of the electronic devices by the user 412, that is, through a passive identification process.

The centralized management system 400 and the electronic devices, the computer 414, phone 416, television 418, and box 420, may be further operable to cause reactive responses to be rendered to the user 412. In particular, the centralized management system 400 may receive a reactive response and a predetermined triggering event from the computer 406. The occurrence of the predetermined triggering event may cause the reactive response to be rendered in accordance with the next advertisement placement opportunity. The centralized management system 400 may disseminate the reactive response and the predetermined triggering event to the electronic devices, the computer 414, phone 416, television 418, and box 420. The electronic device, the computer 414, phone 416, television 418, and box 420, may then monitor incoming content streams for an occurrence of the predetermined triggering event. Upon the occurrence of the triggering event, the reactive response may be dynamically rendered at the next available advertisement placement opportunity.

The centralized management system 400 may comprise several computing devices to accomplish the features described herein. The centralized management system 400 may take the form of the centralized management system 110 illustrated in FIGS. 1 and 3. Additionally, the centralized management system 400 may comprise various servers, including application servers, file transfer servers, and database servers. A computing device suitable for use as part of the centralized management system 400 will now be described. It will be appreciated that this same description may describe a suitable form for computer 414. The computing device may have various forms, including a desktop PC, a dedicated server, a laptop or a portable tablet form, or a hand held form. The features of the computing device described herein may be integrated or separable from the computing device. For example, while the computing device may have a monitor, it may be integrated into the computing device, such as the case of a laptop or tablet type computer.

The computing device suitable for use as part of the centralized management system 400 or computer 414 may include a system memory and a system bus that interconnects various system components including the system memory to a processing unit. The system bus may be any of several types of bus structures including a memory bus or memory controller, a peripheral bus, and a local bus using any of a variety of bus architectures as is known to those skilled in the relevant art. The system memory may include read only memory (ROM) and random access memory (RAM). A basic input/output system (BIOS), containing the basic routines that help to transfer information between elements within the computing device, such as during start-up, is stored in the ROM. The computing device may further include a hard disk drive for reading and writing information to a hard disk, a magnetic disk drive for reading from or writing to a removable magnetic disk, and an optical disk drive for reading from or writing to a removable optical disk such as a CD ROM, DVD, or other optical media.

It will be appreciated that the hard disk drive, magnetic disk drive, and optical disk drive may be connected to the system bus by a hard disk drive interface, a magnetic disk drive interface, and an optical disk drive interface, respectively. The drives and their associated computer-readable media provide nonvolatile storage of computer readable instructions, data structures, program modules and other data for the computing device. Although the exemplary environment described herein employs a hard disk, a removable magnetic disk, and a removable optical disk, it will be appreciated by those skilled in the relevant art that other types of computer readable media which can store data that is accessible by a computer, such as magnetic cassettes, flash memory cards, digital video disks, Bernoulli cartridges, random access memories, read only memories, and the like, may also be used in the exemplary operating environment.

A number of program modules may be stored on the hard disk, magnetic disk, optical disk, ROM or RAM, including an operating system, one or more applications programs, other program modules, and program data. The application programs may include programs suitable for accomplishing the features and tasks described herein with relation to the centralized management system 400 or the computer 414. A user may enter commands and information into the computing device through input devices such as a keyboard and a pointing device, such as a mouse. These and other input devices are often connected to the processing unit through a serial port interface that is coupled to the system bus. Increasingly, such devices are being connected by the next generation of interfaces, such as a universal serial bus interface with a USB port, and to which other hubs and devices may be connected. Other interfaces (not shown) that may be used include parallel ports, game ports, and the IEEE 1394 specification.

A monitor or other type of display device is also connected to the system bus via an interface, such as a video adapter. In addition to the monitor, the computing device typically includes other peripheral output or input devices. For example, an ultra slim XGA touch panel may be used. A resistive finger touch screen may also be used.

Further, it is well understood by those having the relevant skill in the art that a keyboard, scanner, printer, external drives (e.g., hard, disk and optical) and a pointing device may be connected to the computing device suitable for use as part of the centralized management system 400 or the computer 414. In addition, the computing device may be capable of communicating with a network and sending/receiving audio, video and data.

The computing device may operate in a networked environment using logical connections to one or more remote computers or electronic devices as described herein. The types of connections between networked devices include dial up modems, e.g., a modem may be directly used to connect to another modem, ISDN, xDSL, cable modems, wireless and include connections spanning users connected to the Internet. The remote computer may be another personal computer, a server, a router, a network PC, a peer device or other common network node, and typically includes many or all of the elements described in relation to the computing device. In particular, the computing device may be able to communicate with the electronic devices described herein.

When used in a LAN networking environment, the computing device is connected to a local network through a network interface or adapter. The computing device may also connect to the LAN via through any wireless communication standard, such as the 802.11 wireless standard. When used in a WAN networking environment, the computing device typically uses modem or other means for establishing communications over the wide area network. It should be noted that the modem may be internal or external and is connected to the system bus. It will be appreciated that the network connections described herein are exemplary and other means of establishing a communications link between the computers may be used, e.g., from a LAN gateway to WAN.

Generally, the data processors of the computing device suitable for use as part of the centralized management system 400 or the computer 414 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The disclosure described herein includes these and other various types of computer-readable storage media when such media contain instructions or programs for implementing the steps described herein in conjunction with a microprocessor or other data processor. The disclosure also includes the computing device itself when programmed according to the methods and techniques described herein.

Referring now to FIG. 5, there is depicted a flow diagram according to an embodiment of the present disclosure. At step 500, a targeted advertisement along with an associated target profile may be received at a centralized management system. The targeted advertisement and the target profile may be transmitted either separately or together over a computer network. Alternatively, the targeted advertisement and the target profile may be delivered to the centralized management system on a portable storage medium. The targeted advertisement and the target profile are then loaded into the centralized management system. The centralized management system may comprise a computer database having a plurality of user profiles stored therein.

At step 502, a computer application running on the centralized management system may compare the target profile to the user profiles in order to determine a group of targeted users. This comparison may return at least one targeted user. The targeted users may have a profile that matches or is similar to the target profile. At step 504, the targeted advertisements may be delivered to electronic devices of the targeted users. This may be accomplished by transmitting the targeted advertisement from the centralized management system to one or more electronic devices associated with each targeted user. At step 506, the electronic device of each of the targeted user may determine when the targeted user is actually using the electronic device, and, at step 508, the electronic device may dynamically render the targeted advertisement to the targeted user. At step 510, a report regarding the rendering of the targeted advertisement may be generated and electronically transmitted back to the centralized management system.

Referring now to FIG. 6, there is depicted a flow diagram according to an embodiment of the present disclosure. At steps 600 and 602, a content stream is monitored for an advertisement placement opportunity. The advertisement placement opportunity may be a regular advertising slot in the content stream that is already filled with an advertisement. At step 604, an advertisement in the content stream is replaced with a targeted advertisement. This may be accomplished by dynamically switching a device input from a source carrying the content stream to a source carrying the targeted advertisement. The targeted advertisement may be pre-buffered such that the switch to targeted advertisement may be accomplished on-the-fly and without a noticeable interruption to a user. After the targeted advertisement has been rendered, the source of the device input may be immediately switched back to the source carrying the content stream. These steps may provide a seamless integration of the targeted advertisement into the content stream, to the extent possible, such that the switch is unnoticeable to a user.

At step 606, the content owner or content provider of the content stream into which the targeted advertisement was placed may identified. This may require extracting embedded codes from the content stream. In addition, other recognition techniques may be employed, including mapping data points in the content stream and comparing them to known data point mappings in a look-up table. Alternatively, a programming schedule may be employed to identify the content owner or content provider of the content stream into which the targeted advertisements were placed. At step 608, revenues generated by the targeted advertisement placement may be shared with the content owner and/or content provider. In this manner, the content owner and/or providers are compensated for the displacement of their normal advertisements in the content stream.

Referring now to FIG. 7, there is depicted a flow diagram according to an embodiment of the present disclosure. At step 700, a user, referred to herein as the “current user” for purposes clarity, interacts with an electronic device. The electronic device may have the ability to place targeted advertisements. At step 702, the electronic device may determine whether any enrolled users have been previously associated with the electronic device. An enrolled user may be a person who has completed a profile assessment and, in an embodiment hereof, provided a biometric reference sample for identification purposes. If it is determined that an enrolled user has been associated with the electronic device, at step 704, the electronic device may attempt to determine whether the current user of the electronic device is one of the enrolled users. This may be accomplished through a biometric recognition technique, such as a fingerprint scan. In an embodiment of the present disclosure, the current user's fingerprint scan may be compared to the reference samples of the enrolled users to make this determination.

If the current user of the electronic device is determined to be an enrolled user, then at step 705, a determination may be made as to whether any targeted advertisements are linked to the current user. If no targeted advertisements are linked to the current user, then the branch ends at step 709. If it is determined that there is a targeted advertisement linked to the user, then, at step 706, a content stream being rendered by the electronic device may be monitored to recognize an advertisement placement opportunity. Once the advertisement placement opportunity is recognized, then, at step 708, a targeted advertisement may be rendered to the current user in accordance with the identified advertisement placement opportunity. At step 711, it is determined whether another targeted advertisement may be available for placement. If yes, the process loops back to step 706. If no, then this branch then ends at step 709.

If at step 702, it is determined that there are no enrolled users associated with the electronic device, at step 710, the current user of the electronic device may be enrolled. This may include gathering data about a profile of the current user and capturing a biometric reference sample, such as a fingerprint scan. The current user's data, including the current user's profile assessment and biometric reference sample, may then be transmitted and stored at a centralized management system at step 712. At step 714, the centralized management system may then update the electronic device to thereby associate an enrolled user with the electronic device. This branch ends by returning to step 700.

If at step 704, the current user cannot be matched to any of the enrolled users, at step 716, a determination may be made whether the current user is accessing personalized content of any of the enrolled users. If the user is accessing personalized content, then, at step 718, an association between the current user and an enrolled user, to whom the personalized content is typically associated, may be created. Then, targeted advertisements may be delivered to the current user at steps 706 and 708. If the current user is not accessing personalized content, then at step 720, a temporary guest registration may be granted to the current user to thereby allow the current user to operate the electronic device.

Referring now to FIG. 8, there is depicted a flow diagram according to an embodiment of the present disclosure. At step 800, it may be determined that a user is using an electronic device. At step 802, it may be determined whether the content stream being accessed by the user is a subscription-based content stream or a third-party content stream. A subscription-based content stream may be a content stream whose content is delivered specifically to the user at the user's request. A third-party content stream may be a delivered using a broadcast type network. If the content stream is a subscription-based content stream, at step 804, targeted advertisements may be inserted into the subscription-based content stream and the subscription-based content stream is rendered on the electronic device. This branch then ends at step 806.

If the content stream being accessed by the user is generated from a non-subscription based content stream, at step 808, it may be determined whether the non-subscription based content stream has embedded codes in the non-subscription based content stream. If embedded codes are present in the non-subscription based content stream, then at step 810, targeted advertisements may be placed into the non-subscription based content stream. If no embedded codes are found in the non-subscription based content stream, then at step 812, it is determined whether the content can be identified through another method, such as data point mapping of the non-subscription based content stream. If the content cannot be identified, this branch ends at step 806. If the content can be identified at step 802, then at step 814, it may be determined whether permission from the content owner and/or provider to insert targeted advertisements has been obtained. If no permission has been obtained, then this branch ends at step 806. If permission has been obtained, then the targeted advertisements are inserted into the non-subscription based content stream at step 810 and the branch ends at step 806.

Referring now to FIG. 9, there is depicted a flow diagram according to an embodiment of the present disclosure. At step 900, it may be determined if there are any sequencing requirement associated with one or more advertisements. If there are no sequencing requirements, at step 902, then the advertisements may be rendered to a user in accordance with advertisement placement opportunities. If at step 900, it is determined that there are sequencing requirements, then at step 904, the first advertisement in the sequence may be located and buffered. Then at step 906, the first advertisement in the sequence may be rendered to the user in accordance with an advertisement placement opportunity. At step 908, the next advertisement in the sequence may be rendered to the user. At step 910, it may be determined whether any additional advertisements are in the sequence. If yes, then the process may loop back to step 908 to render the next advertisement in the sequence. If no, then a report is generated reporting the completion of the rendering of the sequence at step 912.

Referring now to FIG. 10, there is depicted a flow diagram according to an embodiment of the present disclosure. At step 1000, it may be determined if there are any reactive responses. If no, then the process may end at step 1002. If yes, then at step 1004, a content stream may be monitored for a triggering event. At step 1006, an occurrence of a triggering event may be detected. At step 1008, the reactive response may dynamically rendered to a user. At step 1010, a report is generated regarding the rendering of the reactive response.

Referring now to FIG. 11, there is depicted a flow diagram according to an embodiment of the present disclosure. At step 1100, a target profile and sequencing requirements may be associated with targeted advertisements. At step 1102, at least one user may be targeted based upon the target profile. At step 1104, the targeted advertisements and the sequencing requirements may be delivered to an electronic device for each of the at least one targeted user. At step 1106, it may be determined when the at least one targeted user may be actually using the electronic device, and, at step 1008, the targeted advertisements may be rendered to the at least one user in accordance with the sequencing requirements. At step 1110, a report may be generated regarding the rendering of the targeted advertisements in accordance with the sequencing requirements.

Those having ordinary skill in the relevant art will appreciate the advantages provide by the features of the present disclosure. For example, it is a feature of the present disclosure to provide a system for delivering targeted advertisements to a user of an electronic device. Another feature of the present disclosure is to provide a determination or verification that a targeted advertisement has been rendered to a targeted user. It is a further feature of the present disclosure, in accordance with one aspect thereof, to provide revenue sharing with an owner or provider of a content stream into which a targeted advertisement has been placed. It is a further feature of the present disclosure, to provide a system for delivering advertisements to a user in accordance with a predetermined sequence. It is a further feature of the present disclosure to provide a system for rendering reactive responses upon the occurrence of a triggering event. As used in the following claims, the term “content stream” may be construed to incorporate subscription-based content streams as discussed above.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A system for dynamically rendering a reactive response, said system comprising:
a storage module for storing the reactive response in an electronic storage medium;
an event detection module for monitoring a content stream for an occurrence of a predetermined triggering event;
a rendering module for rendering the content stream and the reactive response; and
a campaign management module for causing said reactive response to be dynamically rendered in response to an occurrence of the predetermined triggering event in the content stream.

2. The system of claim 1, further comprising a switching module for switching a source for the rendering module between the content stream and the reactive response.

3. The system of claim 1, further comprising an opportunity detection module for determining a placement opportunity for the reactive response in relation to the content stream.

4. The system of claim 1, further comprising a user identification module for determining an identity of a user.

5. The system of claim 1, wherein said user identification module utilizes a biometric recognition technique in order to determine the identity of the user.

6. The system of claim 1, further comprising an input module for receiving the content stream.

7. The system of claim 6, wherein said content stream is provided to the input module from at least one of a broadcast television station, a web server, a cable television station, a satellite television station, a broadcast radio station, a cellular telephone network, a wireless network, a wired network, an optical disc player, and an internet television station.

8. The system of claim 1, further comprising a network gateway module for providing a communication path with a centralized management system, wherein said reactive response is received from the centralized management system over the communication path.

9. The system of claim 8, wherein said predetermined triggering event is received from the centralized management system over the communication path.

10. The system of claim 1, further comprising a reporting module for providing information to a centralized management system regarding a rendering of the reactive response to a user.

11. The system of claim 1, wherein said predetermined triggering event and said reactive response are advertisements.

12. A method for dynamically rendering a reactive response, comprising:
monitoring a content stream for an occurrence of a predetermined triggering event; and
causing said reactive response to be dynamically rendered on an output module of an electronic device in response to an occurrence of the predetermined triggering event.

13. The method of claim 12, further comprising switching a source for a rendering module between said content stream and said reactive response.

14. The method of claim 12, further comprising determining a placement opportunity in relation to the content stream for the reactive response.

15. The method of claim 13, further comprising rendering the reactive response in accordance with the placement opportunity.

16. The method of claim 12, further comprising determining an identity of a user.

17. The method of claim 16, further comprising utilizing a biometric recognition technique in order to determine the identity of the user.

18. The method of claim 12, further comprising receiving the content stream.

19. The method of claim 18, further comprising receiving the content stream from at least one of a broadcast television station, a web server, a cable television station, a satellite television station, a broadcast radio station, a gaming console, a cellular telephone network, a wireless network, a wired network, an optical disc player, and an internet television station.

20. The method of claim 12, further comprising receiving the reactive response from a centralized management system.

21. The method of claim 20, further comprising receiving information regarding the predetermined triggering event from the centralized management system.

22. The method of claim 12, further comprising providing information to a centralized management system regarding a rendering of the reactive response to a user.

23. The method of claim 12, wherein said predetermined triggering event and said reactive response comprise advertisements.

24. A centralized management system for rendering a reactive response on a plurality of electronic devices, said system comprising:
a storage module for electronically storing the reactive response;
a campaign management module for associating a triggering event with the reactive response;
a network gateway module for providing a communication path to each of the plurality of electronic devices; and
a communications module for causing the reactive response and the triggering event to be transmitted to each of the plurality of electronic devices using the network gateway module such that said reactive response may be rendered on a given electronic device in response to an occurrence of the triggering event.

25. The centralized management system of claim 24, wherein said campaign management module is further operable to define the triggering event.

26. The centralized management system of claim 24, further comprising a reporting module for receiving and processing information from the plurality of electronic devices regarding renderings of the reactive response.

27. The centralized management system of claim 24, further comprising a profile management and enrollment module for allowing users of the electronic devices to enroll with the centralized management system.

28. The centralized management system of claim 24, wherein said predetermined triggering event and said reactive response are advertisements.

29. The centralized management system of claim 24, wherein said occurrence of the triggering event is determined locally at each of the plurality of electronic devices.

30. A method for rendering a reactive response on a plurality of electronic devices, said method comprising:
electronically storing the reactive response in an electronic storage medium;
associating a triggering event with the reactive response; and
causing the reactive response and the triggering event to be disseminated, through a network gateway module, to each of the plurality of electronic devices such that said reactive response is rendered on a given electronic device in response to an occurrence of the triggering event.

31. The method of claim 30, further comprising the step of defining the trigger event.

32. The method of claim 30, further comprising monitoring at least one content stream for an occurrence of the triggering event.

33. The method of claim 30, further comprising receiving and processing information from the plurality of electronic devices regarding renderings of the reactive response.

34. The method of claim 30, further comprising monitoring at least one content stream for a placement opportunity for the reactive response.

35. The method of claim 30, further comprising obtaining profile information from each of a plurality of users.

36. The method of claim 30, further comprising causing said reactive response and triggering event to be stored locally in an electronic storage medium at each of the electronic devices.

37. The method of claim 30, wherein said triggering event and said reactive response are advertisements.

38. The method of claim 30, further comprising determining the occurrence of the triggering event locally at each of the plurality of electronic devices.

39. A system for rending a plurality of advertisements in a predetermined sequence, said electronic device comprising:
a storage module for electronically storing the plurality of advertisements;
a rendering module for rendering the plurality of advertisements; and
a campaign management module for causing said plurality of advertisement to be rendered by the rendering module in accordance with said predetermined sequence.

40. The system of claim 39, wherein said rendering module is further operable to render a content stream.

41. The system of claim 39, further comprising a switching module for switching a source for the rendering module between the content stream and the plurality of advertisements.

42. The system of claim 39, further comprising a network gateway module for receiving the plurality of advertisements from a centralized management system.

43. The system of claim 42, wherein said network gateway module is further operable to receive the predetermined sequence for the plurality of advertisements from the centralized management system.

44. The system of claim 39, further comprising a user identification module for determining an identity of a user.

45. The system of claim 44, wherein said user identification module utilizes a biometric recognition technique in order to determine the identity of the user.

46. The system of claim 40, further comprising an input module for receiving the content stream.

47. The system of claim 46, wherein said content stream is provided to the input module from at least one of a broadcast television station, a web server, a cable television station, a satellite television station, a broadcast radio station, a gaming console, a cellular telephone network, a wireless network, a wired network, an optical disc player, and an internet television station.

48. The system of claim 39, further comprising a centralized management system, wherein said centralized management system is operable to disseminate said plurality of advertisements and said predetermined sequence.

49. A method of rendering a plurality of advertisements, said method comprising:
receiving the plurality of advertisements from a centralized management system;
storing the plurality of advertisements in an electronic storage medium;
receiving a predetermined sequence for said plurality of advertisements; and
rendering the plurality of advertisements on an output module in accordance with said predetermined sequence.

50. The method of claim 49, further comprising receiving a content stream.

51. The method of claim 50, further comprising monitoring the content stream for an advertisement placement opportunity.

52. The method of claim 50, further comprising switching a source for a rendering module between the content stream and the plurality of advertisements.

53. The method of claim 49, further comprising targeting said plurality of advertisements to a specific user.

54. The method of claim 53, further comprising determining an identity of the user.

55. The method of claim 54, wherein determining the identity of a user comprises utilizing a biometric recognition technique.

56. The method of claim 49, further comprising receiving said content stream from at least one of a broadcast television station, a web server, a cable television station, a satellite television station, a broadcast radio station, a gaming console, a cellular telephone network, a wireless network, a wired network, an optical disc player, and an internet television station.

57. The method of claim 49, further comprising defining said predetermined sequence at the centralized management system.

58. The method of claim 57, further comprising receiving said predetermined sequence from the centralized management system.

59. A centralized management system for rendering a plurality of advertisements in accordance with a predetermined sequence on a plurality of electronic devices, said system comprising:
a storage module for electronically storing the plurality of advertisements;
a campaign management module for associating the plurality of advertisements with the predetermined sequence;
a network gateway module for providing a communication path to each of the plurality of electronic devices; and
a communications module for causing the plurality of advertisements to be transmitted to each of the plurality of electronic devices using the network gateway module such that said plurality of advertisements may be rendered on a given electronic device in accordance with the predetermined sequence.

60. The centralized management system of claim 59, wherein said campaign management module is further operable to define the predetermined sequence.

61. The centralized management system of claim 59, further comprising a reporting module for receiving and processing information from the plurality of electronic devices regarding renderings of the plurality of advertisements.

62. The centralized management system of claim 59, further comprising a profile management and enrollment module for allowing users of the plurality of electronic devices to enroll with the centralized management system.

63. The centralized management system of claim 59, further comprising a comparison module for identifying a group of targeted users for the plurality of advertisements.

64. The centralized management system of claim 59, wherein said campaign management module is further operable to ensure that the plurality of advertisements are rendered in accordance with the predetermined sequence on each of the plurality of electronic devices.

65. A method of rendering a plurality of advertisements in accordance with a predetermined sequence on a plurality of electronic devices, said method comprising:
associating the plurality of advertisements with the predetermined sequence;
disseminating the plurality of advertisements to the plurality of electronic devices over a network;
causing said plurality of advertisements to rendered on an output module in accordance with the predetermined sequence on each of the plurality of electronic devices.

66. The method of claim 65, further comprising disseminating the predetermined sequence to each of the plurality of electronic devices.

67. The method of claim 65, further comprising defining the predetermined sequence.

68. The method of claim 65, further comprising determining a group of targeted users for the plurality of advertisements.

69. The method of claim 68, wherein disseminating the plurality of advertisements to the plurality of electronic devices over a network further comprises disseminating the plurality of advertisements to only electronic devices associated with the group of targeted users.
